(19) United States
(12) Patent Application Publication
(10) Pub. No.: US 2026/0093371 A1
(43) Pub. Date: Apr. 2, 2026

(54) DETECTION OF USER STATE IN ARTIFICIAL INTELLIGENCE SYSTEMS

(71) Applicant: MICROSOFT TECHNOLOGY LICENSING, LLC, Redmond, WA (US)

(72) Inventor: Edwin James GALE, Duvall, WA (US)

(21) Appl. No.: 19/253,666

(22) Filed: Jun. 27, 2025

Related U.S. Application Data
(60) Provisional application No. 63/701,568, filed on Sep. 30, 2024.

(51) Int. Cl. G06F 3/0481; G06F 16/904

(52) U.S. Cl. CPC G06F 3/0481; G06F 16/904

(57) ABSTRACT

Responses by an a artificial intelligence (AI) model are generated based on affective states of the user. In response to receiving a user input, content of the user input is analyzed and an affective state of the user is determined. The affective state is analyzed using a dual model comparison. A response is rendered based on the determined affective state.

### PRIORITY

This application claims the benefit of and priority to U.S. Provisional Application No. 63/701,568 filed Sep. 30, 2024, which is incorporated herein by reference.

### BACKGROUND

Computing systems generally provide interactive and collaborative environments that facilitate communication with and among users. Many applications provide features that are tailored to a user's state, for example a user's affective state. Inaccurate detection of a user's affective state can be detrimental to providing effective and accurate outputs by the applications. When the applications do not optimize interactions with users, user dissatisfaction, production loss, and inefficiencies can result. It is with respect to these considerations and others that the disclosure made herein is presented.

### SUMMARY

Existing affective or emotion models, such as Plutchik's wheel of emotions or the Pleasure-Arousal-Dominance (PAD) model, have shortcomings in providing context-specific emotional labels and characterizing the intricate nuances of human emotional experiences. This limitation and inability to accurately label and represent the user's emotional state can hinder the development of emotionally intelligent artificial intelligence (AI) systems and functions, which is important for developing applications in natural language processing, human-computer interaction, and emotion-based AI functions. For example, in conversational agents, the inability to accurately interpret and respond to users' emotional states can lead to interactions that can be interpreted by the user as impersonal or inappropriate, reducing user satisfaction and trust. By the use of the technologies described herein, AI-based applications are provided the ability to generate specific and context-appropriate emotional labels, thereby significantly improving AI emotional intelligence and interaction quality.

In various embodiments, an AI-based system or application is provided for determining and communicating complex, nuanced user states such as affective states. The disclosed embodiments further enable computational efficiency by simplifying emotional dimensions into binary and three-point scales, reducing the computational resources needed for emotion classification. Furthermore, the disclosed structured approach enables efficient computational implementation, making it more computationally efficient for integration into various AI applications. The disclosed techniques enable enhanced user experiences, particularly in applications such as virtual assistants where accurate detection and response to user states are important.

The disclosed techniques include dual models which serve as comparative frameworks for capturing cognitive evaluations that underpin emotional experiences. The dual models include comparisons such as past vs. present, self vs. others, and expectations vs. reality. By mapping emotions onto these comparisons, the model more accurately accounts for evaluative processes associated with individuals when experiencing emotions.

Additionally, the dual models are complemented by four factors: valence, intensity, control, and context. These factors relate to established dimensional models such as the PAD model, and are further adapted into simplified, discrete categories to enhance computational efficiency. Valence indicates the positivity or negativity of the emotion, intensity indicates its strength, control represents perceived influence over the situation, and context captures social and personal interpretations.

Embodiments include techniques for generating specific emotional labels by combining dual models with the four factors. Additionally, embodiments include subdimensions within dual models and an internal/external expression factor that adds further depth to the model, allowing the model to capture more nuanced emotional states and the distinction between internal feelings and external expressions. This specificity is particularly useful for artificial intelligence systems, such as large language models, which can benefit from precise emotional understanding to interact effectively with users. By providing detailed emotional descriptors, the model enhances AI's capacity for nuanced communication and empathetic engagement.

The examples described herein are provided within the context of collaborative environments but can be applied in any AI- or non-AI-based environment. Additionally, while many of the illustrated examples use LLMs, it should be noted that other models can be utilized without limiting the scope of the disclosure.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter.

### BRIEF DESCRIPTION OF THE DRAWINGS

FIG. 1 illustrates an example system showing aspects of an AI environment for the embodiments disclosed herein.

FIG. 2A illustrates aspects of a routine, according to one embodiment disclosed herein.

FIG. 2B illustrates aspects of a routine, according to one embodiment disclosed herein.

FIG. 3 illustrates an example user interface, according to one embodiment disclosed herein.

FIG. 4 illustrates an example table with subdimensions, according to one embodiment disclosed herein.

FIG. 5 is an example functional diagram illustrating aspects of prompt generation for the embodiments disclosed herein;

FIG. 6 is a computing system diagram showing aspects of an illustrative operating environment for the technologies disclosed herein;

FIG. 7 is a computing system diagram showing aspects of an illustrative operating environment for the technologies disclosed herein;

FIG. 8 is a computing device diagram showing aspects of the configuration and operation of a device that can implement aspects of the disclosed technologies, according to one embodiment disclosed herein.

FIG. 9 is a computing system diagram showing aspects of an illustrative operating environment for the technologies disclosed herein;

FIG. 10 is a computing system diagram showing aspects of an illustrative operating environment for the technologies disclosed herein;

FIG. 11 is a computing device diagram showing aspects of the configuration and operation of a device that can implement aspects of the disclosed technologies, according to one embodiment disclosed herein.

### DETAILED DESCRIPTION

The following Detailed Description describes various techniques for determining user states such as affective states. Technical benefits other than those specifically described herein might also be realized through implementations of the disclosed technologies.

Affective states such as emotions are complex and nuanced. The disclosed embodiments provide a way to systematically analyze and simulate user affective states. As used herein, “affective state” generally refers to a person's near and/or long-term emotional experience. Some embodiments include a multi-dimensional model of emotion that incorporates dual model comparisons that are complemented by four factors: valence, intensity, control, and context. The disclosed techniques enable emotions to be uniquely identifiable by combining these factors. Additionally, the disclosure describes concepts such as subdimensions and an internal/external expression factor to capture nuanced layers of emotional experiences. The disclosed approach aligns with various established emotional theories and provides a framework for emotion simulation using AI.

The disclosed technologies can improve user interaction with a computing device by accurately detecting a user's state and providing timely and relevant information while efficiently using computing resources. Among many benefits provided by the technologies described herein, a user's interaction with a device may be improved, which may reduce the number of erroneous inputs and outputs, reduce the consumption of processing resources, and mitigate the waste of network resources. Other technical effects other than those mentioned herein can also be realized from implementations of the technologies disclosed herein.

As used herein, AI refers to the use of computing systems to perform intelligent tasks such as language processing, analysis, and/or problem solving. Some examples described herein refer to the use of a large language model. However, the techniques disclosed herein can utilize any combination of suitable natural language processing (NLP) algorithms that analyze and model interactions between devices and human language. This can include, but is not limited to, any suitable combination of algorithms such as tokenization algorithms that divide a text into individual words or tokens; part-of-speech (POS) tagging algorithms that assign grammatical labels (e.g., noun, verb, adjective) to each word in a sentence, helping to analyze sentence structure; named entity recognition (NER) algorithms that identify and classify named entities, such as names of people, places, organizations, and more within a text; sentiment analysis algorithms that determine the sentiment or emotional tone of a piece of text, and classifying it as positive, negative, or neutral; text classification algorithms that categorize text documents into predefined classes or categories, such as topic classification and sentiment analysis; machine translation algorithms, like neural machine translation (NMT), that automatically translate text from one language to another; language modeling algorithms, including n-grams and neural language models, and also to referred to herein as a large language model (LLM) or a language model, that are used to predict the probability of a word or sequence of words given the context of the preceding words; named entity disambiguation algorithms which help disambiguate the meaning of named entities by linking them to specific entities in a knowledge base or resolving them to their appropriate entities; text summarization algorithms that generate concise summaries of longer texts, which can be extractive (selecting and combining sentences) or abstractive (generating new sentences); speech recognition algorithms; information extraction algorithms that identify structured information from unstructured text, for extracting events or facts from articles or message attachments; coreference resolution algorithms that determine which words or phrases in a text refer to the same entity, e.g., identifying that “he” and “john” refer to the same person in a sentence; question answering algorithms that answer questions posed in natural language by extracting relevant information from text corpora or knowledge bases; word embeddings algorithms that represent words as dense, continuous-valued vectors, which capture semantic relationships between words; text generation algorithms that use recurrent neural networks (RNNs) and transformers to create human-like text, including for use in chatbots, content generation, and creative writing; dependency parsing algorithms that analyze the grammatical structure of sentences by identifying the relationships between words, including subjects, objects, and modifiers; topic modeling algorithms, such as latent Dirichlet allocation (LDA), to uncover the underlying topics in a collection of documents; and language generation algorithms that create coherent and contextually relevant language, such as generating human-like responses in a conversational AI system. In some embodiments, the system can also utilize audio-to-audio models, where audio files or audio streams are communicated to the model with a prompt for causing the models to generate the responses described herein.

The term generative model, as used herein, refers to a machine learning model employed to generate new content beyond the data with which the model was trained. One type of generative model is a generative language model, which is a model that can generate new sequences of text given some input. One type of input for a generative language model is a natural language prompt, e.g., a query optionally including additional context. For instance, a generative language model can be implemented as a neural network, e.g., a long short-term memory-based model, a decoder-based generative language model, etc. Examples of decoder-based generative language models include versions of models such as GPT, BLOOM, PaLM, Mistral, Gemini, and/or LLaMA. Generative language models can be trained to predict tokens in sequences of textual training data, where tokens are basic units of text that a language model processes. In inference mode (when the model is generating outputs rather than being trained), a generative language model can create new sequences of text that it composes based on patterns learned during training.

In some cases, a generative model can be multi-modal. For instance, a model may be capable of using various combinations of text, images, video, audio, application states, code, and/or other modalities as inputs and/or generating combinations of text, images, video, audio, application states, or code or other modalities as outputs. Here, the term generative language model encompasses multi-modal generative models where at least one mode of output includes natural language tokens. Likewise, the term generative image model encompasses multi-modal generative models where at least one mode of output includes images or video. Examples of multi-modal models include certain GPT variants such as GPT-40, Gemini, Chameleon, etc. Multi-modal models can also include lightweight models such as Phi-3-Vision-128K-Instruct.

In addition, some generative models can include computer vision capabilities. These models are capable of recognizing objects in input images. The term computer vision model encompasses multi-modal models such as one or more versions of CLIP (Contrastive Language-Image Pre-Training) and BLIP (Bootstrapping Language-Image Pre-Training). Note the term “computer vision model” also encompasses non-generative models, such as ResNet, Faster-RCNN, etc. The term vision language model refers to any multi-modal generative model that can generate text describing images or videos, including CLIP, BLIP, Vision-and-Language BERT, Flamingo, Chameleon, etc.

The term prompt, as used herein, refers to input provided to a generative model that the generative model uses to generate outputs. A prompt can be provided in various modalities, such as text, an image, audio, video, etc. The term language generation prompt refers to a prompt to a generative model where the requested output is in the form of natural language. The term image generation prompt refers to a prompt to a generative model where the requested output is in the form of an image.

The term machine learning model refers to any of a broad range of models that provide functions learned from data that maps inputs to outputs by minimizing prediction error, allowing the functions to generalize and make decisions or predictions based on new data. A machine learning model may be a neural network, a support vector machine, a decision tree, a clustering algorithm, etc. In some cases, a machine learning model can be trained using labeled training data, a reward function, or other mechanisms, and in other cases, a machine learning model can learn by analyzing data without explicit labels or rewards.

The disclosed techniques can utilize any type of agent or large language model. For example, based on the architecture one or more of at least four types of LLMs may be used: transformer-based models: e.g., modern LLMs (e.g., GPT, BERT, LLAMA); autoregressive models (e.g., GPT): predict the next word in a sequence; autoencoding models (e.g., BERT): understand and fill in blanks in a sentence; and sequence-to-sequence models (e.g., T5): convert one text sequence to another (e.g., translate English to French). In other examples, based on the purpose or use one or more of at least three types of LLMs may be used: general-purpose models: e.g., GPT-4, Claude, Gemini—trained broadly for many tasks; domain-specific models: trained for specialized fields like medicine (e.g., BioGPT), law, finance, or coding (e.g., CodeLlama, Codex); and instruction-tuned models: fine-tuned to follow human instructions (e.g., ChatGPT, Alpaca, Mistral-Instruct).

An LLM can also include a specialized language model (SLM) that is specifically trained to perform a set of functions. For example, a first SLM can be trained to determine issues with a code base, a second SLM can be trained to identify users, etc. Each SLM can be pre-trained with input data and instructions for causing each SLM to relate and identify specific sets of objects and data sets. The LLM or the SLM can be part of a server executing aspects of the present disclosure and/or the LLM or the SLM can be part of a separate computer in communication with the server.

The terms AI model, AI agent, and LLM as used herein are intended to encompass not only individual models but also composite systems comprising multiple models. Accordingly, in some embodiments, the techniques disclosed herein may be implemented by or in connection with an AI model or AI model system. The AI model system may include, without limitation, a single model, a multimodal system, a system of models, a chain of models, or other configurations in which multiple models operate in cooperation.

The term model may further encompass sub-models, model systems, and mixtures of experts. For example, the model system may include specialized models delegated to perform subtasks, and these subtasks may be orchestrated by a controller or master model to achieve a complex computational result. In some embodiments, the AI system may include reasoning models, models utilizing chain-of-thought prompting techniques, or models designed for delegated task execution. Such configurations may include, but are not limited to, convolutional neural networks (CNNs), deep neural networks (DNNs), transformer-based models, or other machine learning architectures.

These models may be operable to receive one or more input types (e.g., text, image, audio), perform a set of inferential or generative operations based on the input(s), and generate output data that corresponds to predictions, classifications, recommendations, textual responses, or control instructions. The model(s) may be further configured for interoperability with user interfaces, application programming interfaces (APIs), or other software systems to support a variety of functionalities.

Although many examples in the present disclosure are illustrated using LLMs, it should be understood that the disclosure can be implemented using other models. Additionally, although many examples in the present disclosure are illustrated using AI-based systems, it should be noted that the disclosed embodiments can be implemented in systems that do not interact with or incorporate AI-based systems and technologies.

Emotions play an important role in human cognition and social interaction, yet their complexity poses significant challenges for systematic analysis and replication, for example when using artificial intelligence. Traditional models often fail to balance the nuanced nature of emotions with the practical needs of computational implementation. The disclosed embodiments describe a comprehensive emotional model that addresses these issues by integrating key aspects of established theories into a structured, flexible framework suitable for AI applications.

The disclosed techniques include dual models which serve as comparative frameworks for capturing cognitive evaluations that underpin emotional experiences. The dual models include comparisons such as past vs. present, self vs. others, and expectations vs. reality. By mapping emotions onto these comparisons, the model accounts for evaluative processes associated with individuals when experiencing emotions.

Additionally, the dual models can be complemented by four factors: valence, intensity, control, and context. These factors relate to established dimensional models such as the PAD model, and are further adapted into simplified, discrete categories to enhance computational efficiency. Valence indicates the positivity or negativity of the emotion, intensity indicates its strength, control represents perceived influence over the situation, and context captures social and personal interpretations.

Embodiments include techniques for generating specific emotional labels by combining dual models with the four factors. Additionally, embodiments include subdimensions within dual models and an internal/external expression factor that adds further depth to the model, allowing the model to capture more nuanced emotional states and the distinction between internal feelings and external expressions. This specificity is particularly useful for artificial intelligence systems, such as large language models, which can benefit from precise emotional understanding to interact effectively with users. By providing detailed emotional descriptors, the model enhances AI's capacity for nuanced communication and empathetic engagement.

The disclosed embodiments address limitations in existing theories and integrate their strengths. The disclosed embodiments provide a more granular and systematic approach to emotion representation, accommodating complex emotional states that arise from multifaceted evaluations and social contexts. To accommodate AI implementation, the disclosed embodiments provide a foundation for advancing emotional intelligence in artificial systems, with applications ranging from natural language processing to human-computer interaction.

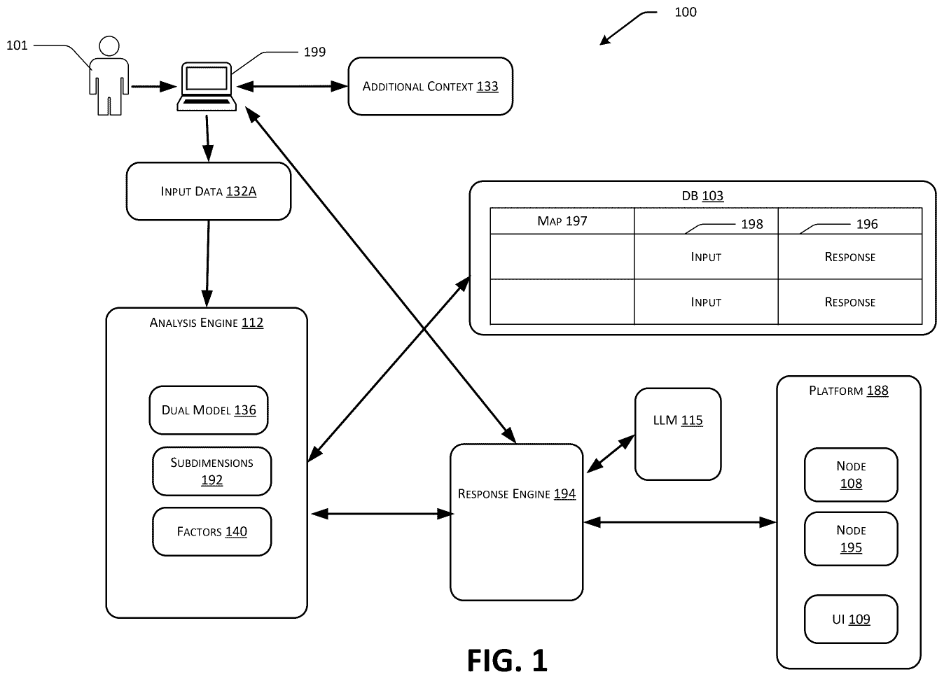

With reference to FIG. 1, an AI framework 100 is configured to receive input data 132A and optionally additional context 133 from a user 101 using device 199. In some embodiments, a user interface (UI) is rendered on device 199, the UI being configured for interacting with the user 101. The multi-platform AI framework 100 is configured to execute an analysis engine 112 that can include dual model 136, subdimensions 192, factors 140, and optionally other features disclosed herein. The analysis engine 112 can be implemented on one or more computing devices such as server running in the multi-platform AI framework 100. In various examples, invoking the analysis engine 112 comprises executing computational operations for receiving the input data 132A, analyzing the content of the input data 132A, generating prompts prior to providing the prompt to an artificial intelligence (AI) model such as LLM 115, and communicating with response engine 194 to render output from the LLM 115 and other components in the multi-platform AI framework 100.

In an embodiment, the analysis engine 112 can receive the input data 132A. In response to receiving the input data 132A, the analysis engine 112 can cause LLM 115 to analyze content of the input data 132A and determine an affective state of the user 101. The input data 132A can include, for example, text, speech, and environmental cues. In an embodiment, the affective state is analyzed using dual model 136 and optionally subdimensions 192 and factors 140, as further described herein. For example, key elements from input data 132A (e.g., direct input, contextual factors) can be identified and extracted from the input data. The analysis engine 112 selects a dual model 136 and subdimension(s) 192 based on analysis of the extracted features. The analysis engine 112 also evaluates factors 140, including valence, intensity, control, context, and/or expression.

Database 103 includes mapping data 197 for mapping emotional labels. The database 103 can include one or more tables or other data structures including, for example, inputs 198 and corresponding responses 196. The data stored in database 103 can include emotion label mapping data and can be used to further inform the analysis of the content of the input data 132A. A response engine 194 can generate a response to the user 101 and can further provide inputs to platform 188 with nodes 108 and 195, and UI 109. The response can be based on an emotion label. The response can be generated to provide an appropriate response based on a more accurate representation of the user's emotional state as indicated by the emotion label.

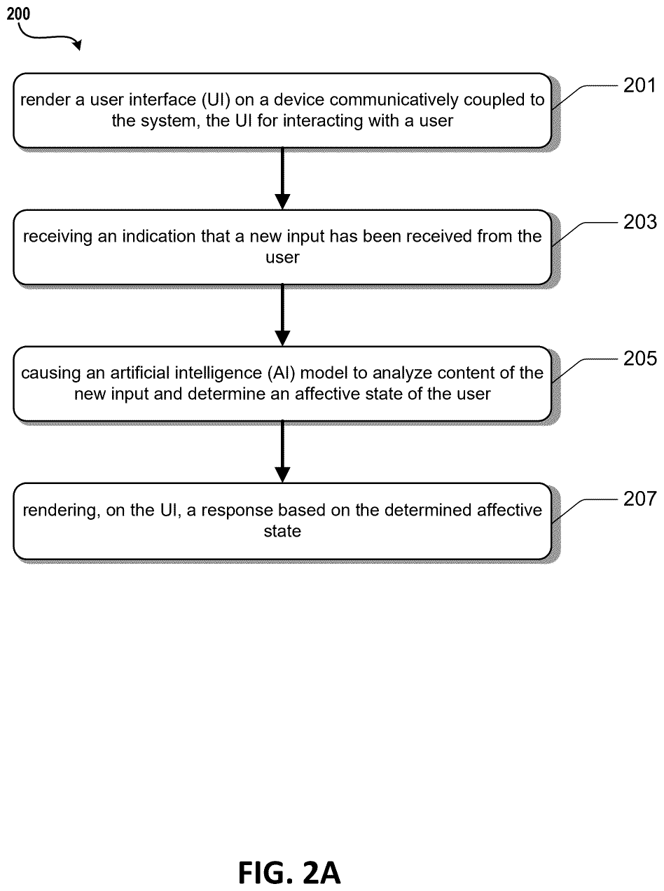

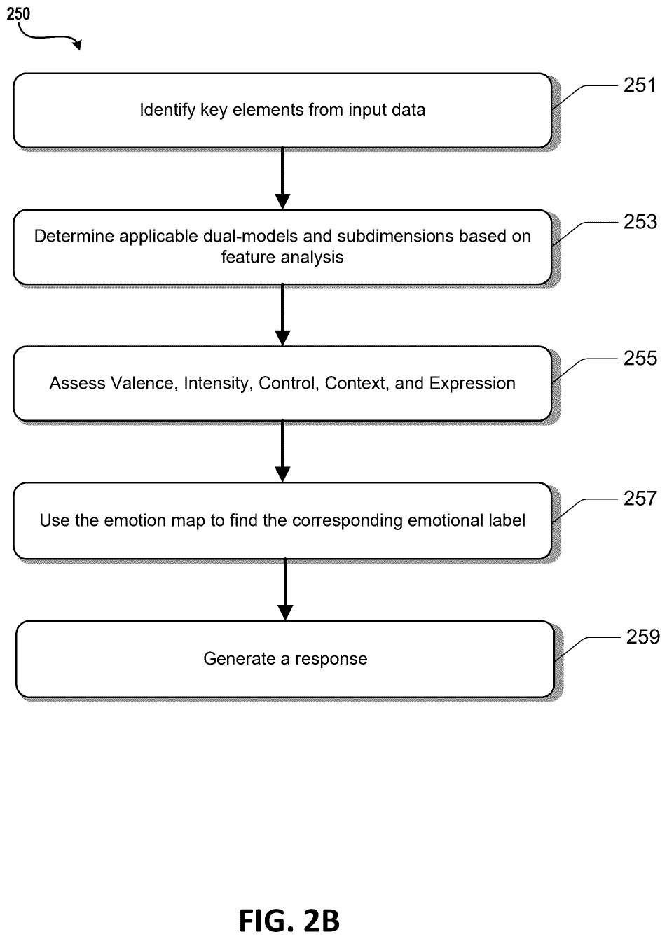

FIG. 2A is a diagram illustrating aspects of a routine 200 according to one embodiment disclosed herein. It should be understood by those of ordinary skill in the art that the operations of the methods disclosed herein are not necessarily presented in any particular order and that performance of some or all of the operations in an alternative order(s) is possible and is contemplated. The operations have been presented in the demonstrated order for case of description and illustration. Operations may be added, omitted, performed together, and/or performed simultaneously, without departing from the scope of the appended claims.

It should also be understood that the illustrated methods can end at any time and need not be performed in their entireties. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system such as those described herein) and/or (2) as interconnected machine logic circuits or circuit modules within the computing system. The implementation is a matter of choice dependent on the performance and other requirements of the computing system. Accordingly, the logical operations may be implemented in software, in firmware, in special purpose digital logic, and any combination thereof.

Additionally, the operations illustrated in FIG. 2A and the other FIGS. can be implemented in association with the example presentation GUIs described with respect to FIGS. 1 and 2B through 11.

Referring to FIG. 2A, operation 201 illustrates an operation to render a user interface (UI) on a device communicatively coupled to the system.

Operation 203 illustrates an operation to receive an indication that an input has been received from the user via the UI. The input data can include, for example, text, speech, and environmental cues.

Operation 205 illustrates an operation to, in response to receiving the indication, cause an artificial intelligence (AI) model to analyze content of the input and determine an affective state of the user. In an embodiment; the affective state is determined using a dual model comparison.

Operation 207 illustrates an operation to render, on the UI, a response based on the determined affective state.

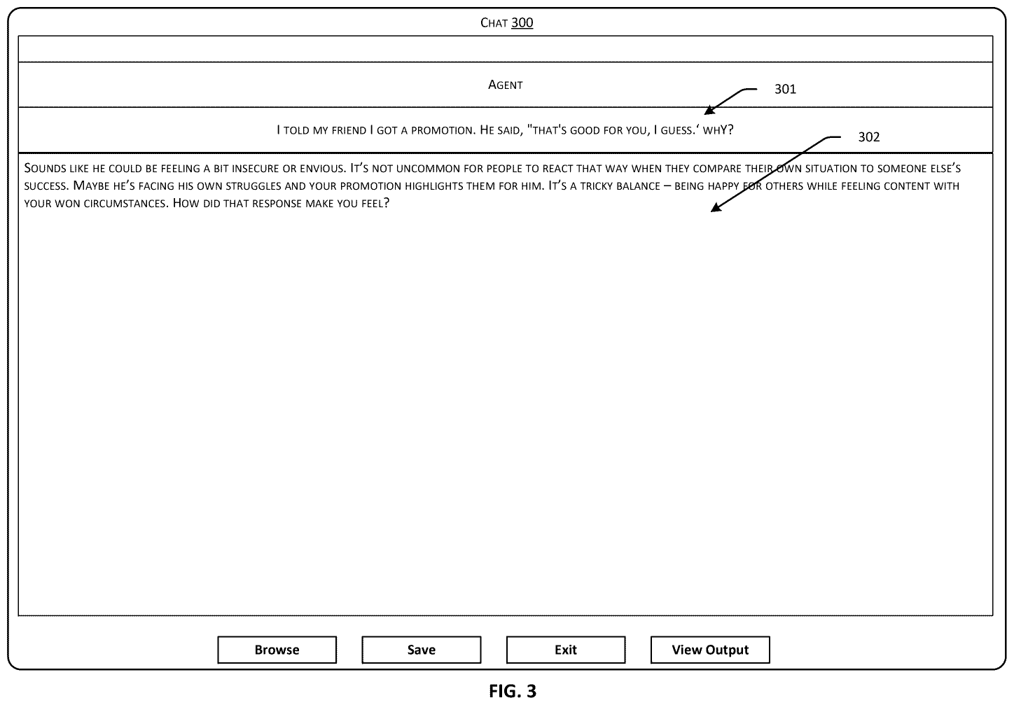

FIG. 3 illustrates an example of a response to a user input in accordance with the disclosed embodiments. FIG. 3 illustrates an example of an AI-based response to a user input in the context of a chat 300, which in this example is, “I told my friend I got a promotion. He said, ‘that's good for you, I guess.’ why?” in a chat pane 301. FIG. 3 illustrates a response generated by a conventional AI-based system that does not implement the disclosed model, shown in response pane 302. FIG. 3 illustrates an example response in a chat session 300 using an AI-based system that illustrates the disclosed model. Conventional AI-based systems can be dismissive and critical of the friend's response, point out negative issues with the friend's response and immediately revert back to the user. The response 302 shown in FIG. 3 to the chat input 301 is more sympathetic, understanding, and supportive using the nuance provided by the disclosed model.

The study of emotions has been a focal point across various fields such as psychology, neuroscience, and artificial intelligence, leading to various models that attempt to categorize, understand, and simulate emotional experiences. The disclosed model builds upon and extends a number of foundational theories and models in this domain, some of which are described below.

Ekman's Basic Emotions Model posits that there are universal, biologically innate basic emotions—specifically joy, sadness, fear, anger, disgust, and surprise—that are recognized across cultures through facial expressions. This categorical approach has significantly influenced emotion recognition research, particularly in cross-cultural studies. However, its limitation lies in its focus on a discrete set of emotions, which may not capture the full complexity and nuance of human emotional experiences necessary for advanced AI applications.

Mehrabian and Russell's PAD Model introduces a dimensional approach to emotions, proposing that emotional states can be represented along three continuous dimensions: Pleasure (Valence), Arousal (Intensity), and Dominance (Control). This model has been instrumental in environmental psychology and human-computer interaction, providing a framework for measuring and predicting emotional responses to various stimuli. While comprehensive, the PAD model's reliance on continuous scales can pose challenges for computational implementation, and it may lack specificity in labeling discrete emotional states, which is crucial for AI systems aiming to generate contextually appropriate emotional responses.

Russell's Circumplex Model of Affect further develops the dimensional perspective by organizing emotions in a circular structure defined by two primary dimensions: Valence (Pleasure-Displeasure) and Arousal (Activation-Deactivation). This model emphasizes the interrelatedness of emotions and their gradual transitions, suggesting that emotions close to each other on the circumplex are more similar. However, it does not incorporate a dominance or control dimension, potentially limiting its applicability in contexts where perceived control significantly influences emotional experiences.

Appraisal Theories of Emotion focus on the cognitive evaluations that precede emotional responses. These theories posit that emotions result from individuals' subjective appraisals of events based on factors such as relevance, goal congruence, and coping potential. While these theories highlight the importance of cognitive processes in emotion generation, they present challenges for computational modeling due to their complexity and the subjective nature of appraisals, which can vary greatly between individuals and contexts.

Plutchik's Wheel of Emotions describes a psychoevolutionary approach, proposing eight primary emotions that can combine to form more complex emotional states. This model provides insights into the intensity and relationships between different emotions. However, its categorical nature and lack of parameters for computational implementation make it less suitable for AI systems that require precise and adaptable emotional modeling.

Social and cognitive theories such as Cognitive Dissonance Theory and Social Comparison Theory emphasize the role of internal conflicts and social comparisons in emotional experiences. These theories underscore how discrepancies between beliefs, actions, or comparisons with others can lead to emotional responses. While influential in understanding the psychological underpinnings of emotions, these theories have not been extensively integrated into computational models due to their abstract and complex nature.

Recent advances in affective computing have focused on multimodal emotion recognition and synthesis, incorporating facial expressions, voice intonations, physiological signals, and natural language processing. Machine learning techniques, especially deep learning, have been employed to improve the accuracy of emotion detection and generation. However, these approaches often require large datasets and significant computational resources and may not provide nuanced interpretation of emotions in varying contexts.

The disclosed model synthesizes and extends established frameworks by the use of the disclosed dual model comparisons, which systematically capture the comparative cognitive processes underlying emotional experiences. By integrating dimensions of valence, intensity, control, context, and the internal/external expression factor, the model addresses the limitations of existing dimensional models by providing specific emotional labels and accounting for both the subjective evaluations and social interpretations of emotions. The inclusion of subdimensions within dual models allows for more granular distinctions, capturing the layered nature of emotional experiences influenced by factors such as personality traits and cultural norms.

Additionally, the disclosed internal/external expression factor accounts for the difference between felt emotions and expressed emotions, which is an important aspect in analyzing user behavior and improving AI interactions. This factor enables the disclosed model to represent scenarios where an individual's internal emotional state may not align with external expressions, which is useful for applications such as virtual assistants and social robots that need to interpret or simulate human emotions accurately.

The disclosed embodiments facilitate computational implementation and bridge the gap between the richness of human emotional experiences and the structured requirements of artificial intelligence systems. The disclosed embodiments facilitate the development of AI-based systems with enhanced emotional intelligence, capable of nuanced understanding, generation, and response to emotional content across a wide range of applications, including natural language processing, human-computer interaction, and affective computing.

In an embodiment, subdimensions are categories within the dual models that capture nuanced emotional experiences arising from specific contexts or dynamics. For example, within the self vs. group/society dual model, the subdimension of self-expectations vs. society-expectations allows the model to represent emotions resulting from the tension between personal standards and societal pressures.

By incorporating subdimensions, the disclosed model can:
capture complex emotions: represent emotions that arise from intricate social dynamics and personal conflicts.
enhance cultural sensitivity: adjust emotional mappings to reflect cultural norms and values more precisely.
align with personality traits: consider how different personality characteristics influence emotional responses within specific contexts.

In an embodiment, the internal/external expression factor accounts for the distinction between internally experienced emotions and externally expressed emotions. This factor recognizes that individuals may not always exhibit their true emotional states due to social norms, personal preferences, or situational factors:
Internal (I): The emotion as genuinely felt by the individual.
External (E): The emotion as expressed or displayed to others.

This internal/external expression factor allows the emotional model to:
represent emotional discrepancies: capture scenarios where there is a mismatch between internal feelings and external expressions.
improve AI interpretation: enable AI systems to consider potential differences between observed behaviors and underlying emotions, enhancing empathy and responsiveness.
support emotional regulation modeling: reflect processes where individuals consciously modify their emotional expressions.

While the PAD Model and the Circumplex Model of Affect provide dimensional approaches to emotions, these models can lack specificity in labeling and contextual understanding. The disclosed model extends the PAD Model and the Circumplex Model of Affect by:
simplifying dimensions: converting continuous scales into discrete categories (e.g., positive/negative valence, low/medium/high intensity) enhances computational efficiency without significant loss of informational value
introducing context and expression factors: adding context and internal/external expression factors captures social interpretations and expression nuances, addressing limitations in handling the impact of social dynamics and personal expression on emotional experiences.
generating specific emotional labels: by combining dimensions with dual models, subdimensions, and expression factors, the model produces precise emotional terms, overcoming the ambiguity often present in dimensional models.

Cognitive appraisal theories emphasize the individual's evaluative processes in emotional responses. The disclosed model integrates cognitive appraisal theories through:
dual models and subdimensions as comparative frameworks: these models represent cognitive evaluations individuals make, aligning with appraisal theories' emphasis on personal interpretation.
internal/external expression: recognizing that appraisals influence not only what emotions are felt but also how they are expressed.

Categorical models such as Ekman's Basic Emotions identify fundamental emotions but often lack the ability to represent complex or blended emotional states. The disclosed model extends Ekman's Basic Emotions by:
allowing for nuanced emotions: the combination of dual models, subdimensions, and factors enables the representation of a broader spectrum of emotions, including complex and mixed feelings.
contextual and expression differentiation: by incorporating context and expression factors, the disclosed model distinguishes between emotions that may appear similar but differ in social acceptability, personal impact, or expression.

The disclosed model identifies eight dual models that represent cognitive evaluations leading to emotional experiences:
1. Past vs. Present: Comparing past experiences or states with the current situation.
2. Future vs. Present: Anticipating future possibilities in relation to the present.
3. Present vs. Present: Contrasting simultaneous aspects of the current moment.
4. Self vs. Others: Evaluating oneself in relation to other individuals.
5. Self vs. Group/Society: Comparing oneself with societal standards and expectations.
   Subdimension: self-expectations vs. society-expectations
6. Self's Standards vs. Actions: Assessing alignment between personal standards and actual behaviors.
7. Expectations vs. Reality: Comparing anticipated outcomes with actual results.
8. Self vs. New Information: Reconciling existing beliefs with new information.

These dual models function as the foundational structures upon which emotions are mapped.

### Emotional Factors

Each dual model is further defined by five factors:
1. Valence (V):
   Positive (P) or Negative (N)
   Indicates the overall pleasantness of the emotion.
2. Intensity (I):
   Low (L), Medium (M), or High (H)
   Reflects the strength of the emotional experience.
3. Control (C):
   Low (L), Medium (M), or High (H)
   Represents the degree of perceived influence over the situation.
4. Context (Ct):
   Positive (P) or Negative (N)
   Captures the social interpretation or perceived impact of the emotion.
5. Internal/External Expression (E):
   Internal (I): The emotion as genuinely felt by the individual.
   External (E): The emotion as expressed or displayed to others.

The inclusion of subdimensions within the dual models, such as the self-expectations vs. society-expectations subdimension, allows the disclosed model to capture more nuanced emotional experiences arising from specific contexts or internal conflicts. By combining these factors with the dual models and subdimensions, the disclosed model generates specific emotional labels that capture the nuances of emotional experiences, including how they are internally experienced and externally expressed.

The disclosed model systematically identifies unique emotions by mapping the combinations of dual models and factors to specific emotional terms. An example for the emotion of pride is as follows:

### Emotion: Pride

Dual model: Self vs. Group/Society
Subdimension: self-expectations vs. society-expectations
Valence: Positive (P)
Intensity: Medium (M)
Control: High (H)
Context: Positive (P)
Expression: Internal (I) and External (E)

The above example shows how the disclosed approach allows for precise emotional labeling, enhancing the ability of AI systems to recognize and simulate complex emotions, including discrepancies between internal feelings and external expressions.

In an embodiment, the disclosed model can be implemented in artificial intelligence systems as follows:

### 1. Situation Assessment:

Input Analysis: The AI system analyzes input data (e.g., text, speech, environmental cues) to identify relevant factors.
Dual Model and Subdimension Selection: Based on the input, the system determines which dual model(s) and subdimension(s) are applicable.

### 2. Factor Evaluation:

Valence Determination: The AI system assesses whether the emotion is positive or negative.
Intensity Assessment: The AI system evaluates the strength of the emotion using contextual cues.
Control Estimation: The AI system determines the perceived level of control the individual feels.
Context Interpretation: The AI system considers social and personal factors to interpret the context.
Expression Analysis: The AI system evaluates the potential difference between internal feelings and external expressions.

### 3. Emotional Label Generation:

By combining the dual model, subdimension, and evaluated factors, the AI system references the emotion map to identify the specific emotional label.
Example: If the input indicates a comparison between self-expectations and society-expectations, with positive valence, medium intensity, high control, positive context, and both internal and external expression, the AI system identifies the emotion as pride.

### 4. Response Generation:

The AI system uses the identified emotion to generate an appropriate response, considering both the content and the emotional tone.
Natural Language Generation: The AI system constructs responses that acknowledge the user's emotional state and provide empathetic or relevant feedback.

More generally, FIG. 2B illustrates an example of a computationally efficient high-level algorithm 250 for emotion analysis and response generation. Such an efficient algorithm also enables the use of smaller models which in turn allows the AI system provider to conserve computing capacity. Smaller models refer to smaller AI models that are generally more lightweight, efficient, and cost-effective for deployment and inference as compared to large-scale models such as GPT-4.

Operation 251 illustrates extracting features which includes identifying key elements from input data. The input data can include, for example, text, speech, and environmental cues. The key elements can be features that are extracted from the input data, such as direct input as well as contextual factors.

Operation 253 illustrates selecting one or more of the dual models and subdimensions, which can include determining applicable dual models and subdimensions based on analysis of the extracted features.

Operation 255 illustrates evaluating factors which can include assessing valence, intensity, control, context, and expression. Valence determination can include whether the emotion is positive or negative. Intensity assessment can include evaluation of the strength of the emotion using contextual cues. Control estimation can include determining the perceived level of control that the user feels. Context interpretation can include consideration of social and personal factors to interpret the context. Expression analysis can include evaluation of the potential difference between internal feelings and external expressions.

Operation 257 illustrates mapping to emotions which can include using an emotion map to find a corresponding emotion label based on the dual model, subdimension, and the evaluated factors.

Operation 259 illustrates generating a response based on the emotion label. The response can be generated to reflect understanding and appropriateness based on the emotion label.

This algorithm provides one example of a structured approach for AI systems to process emotional information systematically, accounting for nuanced factors such as subdimensions and expression differences. The algorithm, and more generally the implementation of the disclosed model, can be executed in a cloud-based system (e.g., server-based), locally at a client or user device, at edge sites providing distributed services, a hybrid model that combines local (on-premises or edge) computing resources with cloud-based services, and the like.

The disclosed emotional model can support various applications across various domains in artificial intelligence, some of which are described below.

### 1. Natural Language Processing (NLP):

Sentiment Analysis: Improves sentiment analysis by providing more nuanced emotional classifications.
Chatbots and Virtual Assistants: Improves interactions by enabling chatbots to recognize and respond more accurately to complex emotions.
Emotion-Aware Language Generation: AI systems can generate text that reflects specific emotional tones, enhancing user engagement.

### 2. Human-Computer Interaction (HCl):

Adaptive Interfaces: Interfaces can adjust their behavior based on the user's emotional state, improving usability and satisfaction.
Emotional Support Systems: AI systems can offer more empathetic responses in applications such as mental health support tools.

### 3. Affective Computing:

Emotion Recognition: Improves accuracy in detecting emotions from multimodal data (e.g., facial expressions, voice tone).
Emotional Simulations: Enables virtual agents and avatars to display realistic emotional behaviors.

### 4. Social Robotics:

Human-Robot Interaction: Robots implementing the disclosed model can interact with humans more naturally, recognizing and responding to emotional cues.
Therapeutic Robots: Assists in therapy by providing emotional support and companionship.

### 5. Educational Technologies:

Intelligent Tutoring Systems: Adapts teaching strategies based on the learner's emotional state to enhance learning outcomes.
Emotional Intelligence Training: Provides tools for developing emotional awareness and regulation skills.

### 6. Gaming and Virtual Reality:

Non-Player Characters (NPCs): NPCs exhibit more realistic and dynamic emotional responses, enhancing immersion.
Player Experience Modeling: Adjusts game difficulty and content based on the player's emotional engagement.

### 7. Customer Service Automation:

Emotionally Intelligent Agents: Improves customer satisfaction by addressing emotional concerns effectively.
Conflict Resolution: AI mediators can understand and de-escalate emotionally charged situations.

### 8. Market Research and Social Media Analysis:

Emotion Mining: Analyzes consumer emotions towards products or brands with greater precision.
Trend Analysis: Detects shifts in public sentiment by identifying complex emotional patterns.

The disclosed model provides a structured and efficient approach to recognizing and simulating human emotions in AI systems that enables more efficient use of tokens and computational resources, allowing for significant savings in tokens through the use of smaller, cost-effective AI models without compromising performance.

In AI applications, particularly those involving NLP and affective computing, efficient token usage and computational cost are important considerations. By systematically capturing emotions with discrete categories and specific emotional labels, the model reduces the complexity and size of input data, thereby saving tokens and enabling the use of smaller, more affordable models.

The disclosed model employs discrete categories for emotional factors such as valence (positive/negative), intensity (low/medium/high), control (low/medium/high), and context (positive/negative). This structured approach simplifies emotional representation, reducing the need for verbose descriptions and lengthy contextual explanations.

In an embodiment, an example formula for token efficiency can be expressed as: Let (T) be the total number of tokens required for emotional representation. The discrete categorical approach can be expressed as: [T=\sum_{i=1}\hat{ }{n} (d_i+v_i+i_i+c_i+c_i+\text {context} i)] where (d_i) is the Dual model, (v_i) is Valence, (i_i) is Intensity, (c_i) is Control, (e_i) is Expression, and (\text {context} _i) is Context. Since each factor is represented by a fixed, discrete value, (T) remains consistently low.

For example, instead of a lengthy textual description, “The person feels an overwhelming sense of joy and excitement about the future,” the model can use a concise label: “Future vs. Present, Positive, High, High, Positive.” This significantly reduces the token count.

By generating specific emotional labels through combinations of dual models and factors, the model eliminates ambiguity and minimizes the need for extensive clarifications, further reducing the number of tokens.

The following is another example of how the model can reduce token usage:
Verbose description: “The individual is deeply saddened by the loss and feels a profound sense of despair.”
Model label: “Past vs. Present, Negative, High, Low, Negative (Despair).”

The specific label “Despair” succinctly encapsulates the emotional state, streamlining data processing and reducing token usage.

As discussed, the disclosed model's structured and discrete approach allows for simplified emotional representations that can be processed using smaller models. This reduces the computational load and memory requirements, making it feasible to use smaller, less resource-intensive AI models. Below is an example formula for model size reduction: Let (M) be the model size. Simplifying emotional representation decreases the complexity (C) that the model needs to process: [M \propto \frac {1} {C}]. By transforming continuous emotional data into discrete categories, (C) is minimized, allowing (M) to be reduced.

The high-level algorithm for emotion analysis and response generation, as shown in FIG. 14, is designed to be computationally efficient, enabling smaller models to perform effectively. The algorithm reduces the complexity of emotional processing, making it suitable for implementation in smaller models.

Additionally, the discrete and specific nature of the disclosed emotional model reduces the variability in training data, allowing smaller models to achieve high accuracy with less data. This results in lower training costs and faster training times. An example formula for determining training data reduction is provided below:
Let (D) be the amount of training data required. The reduced variability (V) in emotional representation lowers (D): [D \propto \frac {1} {V}]. By discretizing emotions into specific categories, (V) is minimized, reducing (D).

In some embodiments, the disclosed model can accommodate variations in emotional experiences and expressions across cultures. To enable the model's applicability in diverse cultural contexts, while maintaining simplicity, the following systemic adaptations can be implemented in some embodiments:

### 1. Core Model Preservation:

The disclosed dual model structure and factors (Valence, Intensity, Control, Context) are maintained as the foundation of the emotional model.

### 2. Cultural Weighting System:

A cultural weighting system is incorporated that modifies the interpretation and importance of existing factors without adding new dimensions to the core model.

### Formula Modification:

$$Emotion = f ( dual model , Valence * Cv , Intensity * Ci , Control * Cc , Context * Cx )$$

Where Cv, Ci, Cc, and Cx are cultural weighting coefficients for Valence, Intensity, Control, and Context respectively.

### 3. Culture-Specific Sub-Models:

Culture-specific sub-models are developed that extend from the core dual models. The sub-models can include:
a) Culture-specific emotions (e.g., “amae” in Japanese culture)
b) Modified relationships between emotions
c) Adjusted thresholds for emotion categorization

### 4. Cultural Filters:

Implement cultural filters that adjust the output of the core model. These filters:
a) Modify the expression intensity of emotions
b) Adjust the likelihood of certain emotions in specific contexts
c) Reframe the interpretation of emotions based on cultural norms

The disclosed model can be enhanced to accommodate cultural contexts as follows:

### 1. Core Model Enhancement:

A database is provided with cultural weighting coefficients for major cultural groups.

The system applies these coefficients to the core emotion calculation.

### 2. Sub-Model Integration:

A modular system is provided where culture-specific sub-models are used in the core model. Transitions are smoothed between core and sub-model emotions.

### 3. Cultural Filter Application:

Post-processing is performed that applies cultural filters to the emotion output.

### 4. Personality-Weighted Emotional Prioritization

In the disclosed model, individual differences in emotional prioritization are addressed through integration of baseline personality traits. Personality traits, such as those defined by the Big Five model (conscientiousness, openness, agreeableness, extraversion, and neuroticism), are used to explain variation in emotional responses to identical events and can identify prioritization amongst the base emotions identified by the dual-models. This allows for dynamic adjustment of filters based on specific cultural contexts.

The disclosed model can be enhanced to accommodate individual differences in emotional prioritization as follows:

Using the example of the emotion “Pride” in the “Self vs. Group/Society” dual model:

### Core Model:

$$Pride = f ( Self vs . Group / Society , Positive , Medium , High , Positive )$$

### Cultural Adaptation for East Asian Context:

### 1. Apply Cultural Weights:

$$Pride = f ( Self vs . Group / Society , Positive * 0.8 , Medium * 1.2 , High * 0.9 , Positive * 1.1 )$$

This adjustment reduces the positive valence, increases the intensity, slightly reduces the sense of control, and increases the positive context to align with cultural norms.

### 2. Sub-Model Extension:

Introduce “Group Pride” as a culturally specific emotion closely related to “Pride” but with a more collective focus.

### 3. Cultural Filter:

Apply a filter that reduces the expression intensity of pride in public settings and reframes it as “Group Achievement Appreciation.”

Benefits of applying cross-cultural considerations to the disclosed model include:
1. Flexibility: The model can adapt to various cultural contexts without fundamentally altering the core model structure.
2. Simplicity: The core formula remains simple, while allowing for complex cultural variations through weights, sub-models, and filters.
3. Scalability: New cultural adaptations can be added without requiring a complete overhaul of the existing model.
4. Comparability: The consistent base model allows for meaningful cross-cultural comparisons.
5. AI Implementation: The structured approach facilitates easier implementation in AI systems, allowing for dynamic cultural adjustments.

Additionally, the disclosed model can accommodate specific cultural differences as follows:
1. Emotion Lexicon: Culture-specific emotions can be incorporated through sub-models without disrupting the core structure.
2. Valence and Arousal Interpretation: Cultural weights can be used to adjust the interpretation of valence and intensity.
3. Collectivist vs. Individualist Perspectives: Filters and sub-models can account for varying perspectives on self vs. group emotions.
4. Display Rules: Cultural filters can modify expression intensities based on cultural norms.
5. Moral Emotions: Weighting and sub-models can adjust the significance of moral emotions in different cultures.
6. Time Orientation: Sub-models can incorporate culture-specific time perspectives within existing dual models.
7. Hierarchical Contexts: Filters can adjust emotional expressions based on social hierarchies and contexts.
8. Holistic Emotion-Body Connection: Sub-models can incorporate physiological aspects of emotions for cultures with more holistic views.
9. Spiritual/Religious Dimension: Sub-models and filters can account for spiritual or religious aspects of emotions in relevant cultures.

In an embodiment, the disclosed model can be adapted to implement this culturally adaptive emotional model as follows:
1. Accurate cultural coefficients, sub-models, and filters can be developed through collaborative research with cultural experts and psychologists from diverse backgrounds.
2. The model's adaptations in various contexts can be validated through extensive cross-cultural studies.
3. A dynamic AI system can be developed that can seamlessly switch between cultural adaptations based on context.
4. The cultural database can be regularly updated to reflect evolving cultural norms and emerging research findings.

By incorporating these systemic adaptations, the disclosed emotional model can continue to be flexible, inclusive, and applicable across a wide range of cultural contexts, while maintaining its fundamental simplicity and coherence. This approach enhances its utility in global AI applications, cross-cultural communication studies, and psychological research.

The following examples show how general culture differences can be incorporated into the disclosed model:

### 1. Japanese Culture-Expression of Anger

Core Model: Present vs. Present (Anger)

### Implementation:

Cultural Weights: Reduce intensity and expression of anger
Filter: Increase likelihood of suppressing anger in public settings

### Formula:

$$Anger ( Japanese context ) = f ( Present vs . Present , Negative * 1. , Medium * 0.7 , High * 1.2 , Negative * 0.9 )$$

This adjustment reflects the Japanese cultural norm of suppressing strong negative emotions, especially in public.

### 2. Italian Culture-Expression of Joy

Core Model: Present vs. Present (Joy)

### Implementation:

Cultural Weights: Increase intensity and expression of joy
Filter: Enhance physical and vocal expressions of happiness

### Formula:

$$Joy ( Italian context ) = f ( Present vs . Present , Positive * 1.2 , High * 1.3 , Medium * 1.1 , Positive * 1.2 )$$

This modification accounts for the more expressive and demonstrative nature of emotion in Italian culture, particularly for positive emotions.

### 3. British Culture-Expression of Pride

Core Model: Self vs. Group/Society (Pride)

### Implementation:

Cultural Weights: Reduce intensity and public expression of pride
Filter: Increase likelihood of understated or self-deprecating expressions

### Formula:

$$Pride ( British context ) = f ( Self vs . Group / Society , Positive * 0.9 , Low * 1.1 , Medium * 1. , Positive * 0.8 )$$

This adjustment reflects the British cultural tendency towards modesty and understatement, especially regarding personal achievements.

### 4. American Culture-Expression of Confidence

Core Model: Self vs. Others (Confidence)

### Implementation:

Cultural Weights: Increase intensity and expression of confidence
Filter: Enhance verbal expressions of self-assurance Formula:

$$Confidence ( American context ) = f ( Self vs . Others , Positive * 1.2 , High * 1.1 , High * 1.2 , Positive * 1.1 )$$

This modification accounts for the American cultural value placed on self-confidence and its open expression.

### 5. German Culture-Expression of Directness (Often Perceived as Rudeness by Others)

Core Model: Self vs. Others (Honesty/Directness)

### Implementation:

Cultural Weights: Increase intensity of direct communication
Filter: Reduce softening of critical feedback

### Formula:

$$Directness ( German context ) = f ( Self vs . Others , Neutral * 1. , High * 1.2 , High * 1.1 , Neutral * 1. )$$

This adjustment reflects the German cultural preference for direct communication, which may be perceived as blunt or rude in other cultures.

The above examples demonstrate how the disclosed model can account for well-known cultural and other differences in emotional expression and interpretation. For example, weights can be adjusted based on various personality classification frameworks. By adjusting weights, differences can be modeled within the existing framework, allowing for more accurate emotional simulations and understanding.

In the disclosed embodiments, individual differences in emotional prioritization are addressed through integration of baseline personality traits. Personality traits, such as those defined by the Big Five model (conscientiousness, openness, agreeableness, extraversion, and neuroticism), are used to explain variation in emotional responses to identical events.

In an example, two individuals—Jack and Sarah—may experience the same negative outcome but exhibit differing dominant emotional reactions based on personality-driven weighting. Jack, characterized by low conscientiousness, high openness, and low agreeableness, will exhibit emotional responses dominated by the Expectations vs. Reality comparison, manifesting primarily as regret and despair, with minimal shame or social concern due to low sensitivity to interpersonal evaluation. In contrast, Sarah, exhibiting high conscientiousness and high agreeableness, will prioritize emotional responses linked to social evaluation, such as shame, disgrace, and self-disgust, while experiencing minimal regret or despair, as her actions were externally motivated and against personal judgment.

Thus, in one embodiment the system dynamically adjusts emotional weighting based on individual personality profiles, providing improved modeling of emotional prioritization across varying contexts. Research supporting this model demonstrates that higher agreeableness correlates with increased sensitivity to interpersonal conflict and shame.

This personality-driven weighting mechanism ensures that identical events can activate the same underlying emotional comparison models but prioritize different emotional factors based on individual differences. While existing models such as PAD (Pleasure-Arousal-Dominance) partially capture emotional dimensions, they do not account for the influence of personality and contextual interpretation. The disclosed approach remedies this shortcoming by incorporating both personality-based weighting and contextual interpretation, enabling the system to simulate more accurate and individualized emotional responses.

The following examples illustrate the application of the disclosed emotional model in an AI-based system:
Scenario: A user has just completed a challenging project at work and is reflecting on the experience.
User: “I've just finished a big project at work. It was really tough, and I'm not sure how I feel about it. The outcome wasn't exactly what I expected, but I learned a lot.”
Before (Default AI response):
AI: Congratulations on completing your big project! It's normal to have mixed feelings after finishing something challenging. The experience you've gained is valuable, even if the outcome wasn't exactly as expected. How do you think this project will impact your future work?

### Internal AI Processing:

### Factors:

1. Valence: Positive (P)
Reason: The user completed a challenging project and learned from it, which are generally positive outcomes.
2. Intensity: Medium (M)
Reason: The user expresses uncertainty and mixed feelings, suggesting a moderate emotional intensity rather than extreme highs or lows.
3. Control: Medium (M)
Reason: The user completed the project, indicating some control, but the unexpected outcome suggests they didn't have full control over the results.

These factors are mapped across the relevant dual models:
1. Past vs. Present (P, M, M):
Emotion: Contentment (Past)
Relation: The user has completed a challenging project, leading to a sense of contentment with their past efforts.
2. Future vs. Present (P, M, M):
Emotion: Anticipation
Relation: The learning experience from the project creates anticipation for future work and growth.
3. Self's Standards vs. Actions (P, M, M):
Emotion: Integrity
Relation: Despite unexpected outcomes, the user's effort and learning align with their personal standards.
4. Expectations vs. Reality (P, M, M):
Emotion: Fascination
Relation: The unexpected outcome and learning experience create a sense of fascination with the project's results.
Improved AI Response:
It sounds like you're processing a mix of emotions after completing this challenging project. There's a sense of contentment in having overcome the difficulties, coupled with anticipation about how this experience might shape your future work. The unexpected outcome seems to have sparked a fascinating learning opportunity, which aligns well with your personal growth. While the results may not have met your initial expectations, your integrity in seeing the project through is commendable. How do you think this experience has changed your perspective on tackling future projects?
Explanation:
The AI model's response integrates the identified emotions. It acknowledges the user's contentment with completing the project, the anticipation for future work based on the learning experience, the fascination with unexpected outcomes, and the integrity shown in persevering through challenges. The response validates the user's mixed feelings while highlighting the positive aspects of growth and learning. The final question encourages further reflection, allowing the user to explore how this experience might influence their approach to future challenges.

Negative Scenario: A user has recently lost their job due to company downsizing.

User: “I just got laid off from my job. The company is downsizing, and I didn't see it coming. I've been there for five years, and now I don't know what to do.”

Before (Default AI response):
AI: I'm sorry to hear about your job loss. Unexpected layoffs can be very stressful and disorienting. It's understandable to feel uncertain about your next steps. Have you considered reaching out to your professional network or updating your resume? Remember, many people face similar situations and manage to find new opportunities.

### Internal AI Processing:

### Factors:

1. Valence: Negative (N)
Reason: Job loss is generally a negative experience, especially when unexpected.
2. Intensity: High (H)
Reason: The user expresses shock and uncertainty, indicating a strong emotional response.
3. Control: Low (L)
Reason: The layoff was due to company downsizing, a situation beyond the user's control.
Mapping these factors across the relevant dual models:
1. Past vs. Present (N, H, L):
Emotion: Despair
Relation: The sudden shift from a stable 5-year job to unemployment can evoke feelings of despair.
2. Future vs. Present (N, H, L):
Emotion: Fear
Relation: The uncertainty about future employment prospects can lead to fear.3. Expectations vs. Reality (N, H, L):
Emotion: Shock
Relation: The unexpected nature of the layoff has caused a shocking disconnect between expectations and reality.
4. Self vs. Group/Society (N, H, L):
Emotion: Isolation
Relation: Being singled out in a downsizing can lead to feelings of isolation from the workplace community.

### Improved AI Response:

I can sense that this sudden job loss has hit you hard. It's a lot to process, especially after dedicating five years to the company. The shock of the unexpected layoff and the fear of an uncertain future are completely valid feelings. It's natural to feel a bit lost or even isolated right now, as if the rug has been pulled out from under you. But remember, your worth isn't defined by this job, and this setback doesn't erase your five years of experience and growth. As overwhelming as it might feel, try to take it one step at a time. Is there someone in your support network you can reach out to for emotional support or professional advice?

### Explanation:

The AI's response acknowledges the user's despair and shock. It validates the fear and uncertainty about the future while also addressing the potential feeling of isolation. The response empathizes with the user's situation, recognizing the intensity of their emotions and their lack of control over the circumstances. It gently reminds the user of their value beyond this job and suggests taking small steps, acknowledging the overwhelming nature of the situation. The final question encourages the user to seek support, which can help combat feelings of isolation and provide practical assistance. This approach shows understanding of the complex emotional state without listing emotions explicitly, and offers a supportive, forward-looking perspective.

Contextually-Nuanced Scenario: A user is confused about a friend's reaction to their promotion.
User: “I just got a big promotion at work, and I was excited to tell my friend about it. But when I did, they seemed upset and said, ‘That's great for you, I guess.’ I don't understand why they reacted that way. Can you help me figure out what's going on?”
Before (Default AI response):
AI: It sounds like your friend's reaction wasn't what you expected. Sometimes people can react unexpectedly to good news, especially if they're going through their own struggles. It might be helpful to have an open conversation with your friend to understand their feelings better.

### Internal AI Processing:

Analysis of this situation using the disclosed emotional model, focusing on the context differences:
1. User's emotion:
Dual Model: Self vs. Group/Society
Valence: Positive
Intensity: High
Control: Medium
Context: Positive
Emotion: Pride
2. Friend's perceived emotion:
Dual Model: Self vs. Others
Valence: Negative
Intensity: Medium
Control: Low
Context: Positive
Emotion: Envy
An important insight is the context difference. The friend's emotion has a positive context (the user's promotion is objectively positive) but a negative valence (the friend feels bad about it).

### AI Model Response:

I can see why you're confused by your friend's reaction. It seems like there's a mismatch between what you expected and how they responded. Your excitement about the promotion is completely valid—it's a significant achievement that you should be proud of. However, your friend's reaction might be coming from a place of envy or insecurity.
It's important to understand that envy is a complex emotion. Your friend might genuinely be happy for your success on one level (which is positive), but simultaneously feel bad about their own situation or progress in comparison (which is why the feeling may appear negative). This doesn't make them a bad friend; it's a very human reaction.
Their comment, “That's great for you, I guess,” suggests they're struggling to reconcile these conflicting feelings. They might be trying to express happiness for you while also grappling with their own disappointment or self-doubt.
Consider having a heart-to-heart conversation with your friend. You could acknowledge that your news might have caught them off guard and ask if everything is okay with them. This approach shows empathy and might encourage them to open up about their own situation or feelings.
Remember, it's possible to be happy for someone and envious at the same time. By understanding this, you can navigate the situation with compassion, both for your friend and for yourself as you celebrate your well-deserved success.

### Explanation:

This response leverages the context difference to provide a nuanced understanding of the friend's reaction. By recognizing that envy can have a positive context (acknowledging the good thing that happened to the other person) but a negative valence (feeling bad about oneself in comparison), the AI can explain the seemingly contradictory reaction of the friend.

This insight allows the AI system to provide a more empathetic and insightful response, helping the user understand the complexity of human emotions and reactions. It also guides the user towards a more compassionate approach to the situation, potentially improving their relationship with their friend.

The power of the context difference in this scenario is that it allows the AI system to distinguish between the objective situation (a positive event—the promotion) and the subjective emotional experience of the friend (a negative feeling—envy). This distinction enables a much more sophisticated and helpful analysis of the interpersonal dynamics at play.

The following provides an example of an assistant writing scenario with multiple perspectives in the boss' request.

Before using the disclosed dual model:
Boss: [Writing an email] “Team, our project is behind schedule. We need to work harder to meet the deadline. I expect everyone to put in extra hours this week.”
AI: “Consider changing ‘work harder’ to ‘increase our efforts’ for a more professional tone. Also, you have a typo in ‘deadline’—it's spelled ‘deadline’.”
   After using the disclosed model:
Boss: [Writing an email] “Team, our project is behind schedule. We need to work harder to meet the deadline. I expect everyone to put in extra hours this week.”
AI: “Your message is clear, but it might be interpreted as overly demanding. Consider this revision:
‘Team, I've noticed we're behind schedule on our project. I appreciate the hard work you've all put in so far. To ensure we meet our deadline, we may need to increase our efforts this week. I'm open to discussing how we can best approach this challenge together. Let's schedule a quick team meeting to brainstorm efficient ways to get back on track.’”
This revision aims to acknowledge the team's efforts, express the urgency without seeming accusatory, and invite collaboration rather than demanding extra hours.
   Explanation of the emotional analysis:
1. Dual model: Self vs. Group/Society
The original message compares the boss's expectations (self) with the team's performance (group).
2. Valence: Negative
The original message focuses on shortcomings and demands, likely to evoke negative emotions.
3. Intensity: Medium
The urgency of the situation suggests medium intensity.
4. Control: High for the boss, Low for the team
The boss is exerting high control, while the team may feel low control over their time.
5. Context: Negative
The demand for extra hours without acknowledgment of effort could be perceived negatively.

The AI model identified potential Negative-to-Positive (N-P) reactions from the team (resentment, stress) and Positive-to-Negative (P-N) interpretations of the boss's intentions (care for the project perceived as lack of empathy).

To address this, the resulting suggestion is provided:
1. Acknowledges current efforts (increasing Positive context)
2. Frames the challenge as a shared one (balancing Self vs. Group)
3. Invites collaboration (increasing team's sense of Control)
4. Focuses on efficiency rather than just time (shifting from purely Negative to a more balanced perspective)
This approach aims to maintain the urgency of the message while reducing the likelihood of negative emotional responses and misinterpretations.

The Big Five Personality Traits are also known as OCEAN, and include Openness, Conscientiousness, Extraversion, Agreeableness, and Neuroticism.

### Big Five Personality Traits and Dual Models

1. Openness to Experience
   Dual Model Alignment: Self vs. New Information
   Typical Emotions: Curiosity, Fascination, Bewilderment
   Factors: Positive Valence, Medium/High Intensity, High Control
   Context: Positive (P) for curiosity and fascination; Negative (N) for bewilderment
2. Conscientiousness
   Dual model Alignment: Self's Standards vs. Actions
   Typical Emotions: Guilt, Satisfaction, Responsibility, Self-Respect
   Factors: Positive/Negative Valence, Medium Intensity, Medium/High Control
   Context: Negative (N) for guilt and responsibility; Positive (P) for satisfaction and self-respect
3. Extraversion
   Dual model Alignment: Present vs. Present
   Typical Emotions: Joy, Happiness, Enthusiasm, Boredom
   Factors: Positive Valence, High Intensity, High Control
   Context: Positive (P) for joy and enthusiasm; Negative (N) for boredom
4. Agreeableness
   Dual model Alignment: Self vs. Others
   Typical Emotions: Compassion, Empathy, Admiration, Resentment
   Factors: Positive/Negative Valence, Medium Intensity, Medium Control
   Context: Positive (P) for compassion and empathy; Negative (N) for resentment
5. Neuroticism
   Dual model Alignment: Future vs. Present
   Typical Emotions: Anxiety, Fear, Worry, Hope
   Factors: Negative Valence, High Intensity, Low Control
   Context: Negative (N) for anxiety and fear; Positive (P) for hope

### Patterns and Specific Alignments

High Control and Intensity: Extraversion aligns with high control and intensity in the Present vs. Present model.
Low Control and High Intensity: Neuroticism aligns with low control and high intensity in the Future vs. Present model.
Medium Control: Conscientiousness and Agreeableness align with medium control across their respective dual models.
Curiosity and Fascination: Openness to Experience aligns with emotions centered around new information and experiences.

The Myers-Briggs Type Indicator (MBTI) classifies personalities into 16 types based on four dichotomies: Extraversion (E) vs. Introversion (I), Sensing(S) vs. Intuition (N), Thinking (T) vs. Feeling (F), and Judging (J) vs. Perceiving (P).

MBTI Dichotomies and dual models
1. Extraversion (E) vs. Introversion (I)
   Dual model Alignment: Present vs. Present
   Typical Emotions: Joy, Enthusiasm, Calm, Serenity
   Factors: Positive Valence, Medium/High Intensity, High Control
   Context: Positive (P) for joy and enthusiasm; Negative (N) for calm and serenity (for I types)
2. Sensing(S) vs. Intuition (N)
   Dual model Alignment: Expectations vs. Reality
   Typical Emotions: Surprise, Amazement, Disappointment, Curiosity
   Factors: Positive/Negative Valence, Medium Intensity, Medium Control
   Context: Positive (P) for surprise and amazement; Negative (N) for disappointment
3. Thinking (T) vs. Feeling (F)
   Dual model Alignment: Self vs. Others
   Typical Emotions: Admiration, Contempt, Compassion, Resentment
   Factors: Positive/Negative Valence, Medium Intensity, Medium Control
   Context: Positive (P) for admiration and compassion; Negative (N) for contempt and resentment
4. Judging (J) vs. Perceiving (P)
   Dual model Alignment: Future vs. Present
   Typical Emotions: Determination, Anxiety, Hope, Worry
   Factors: Positive/Negative Valence, Medium/High Intensity, Low/High Control
   Context: Positive (P) for determination and hope; Negative (N) for anxiety and worry

### Patterns and Specific Alignments

High Control: Judging types (J) align with high control in Future vs. Present.
Medium Intensity: Thinking (T) and Feeling (F) types align with medium intensity in Self vs. Others.
Surprise and Curiosity: Sensing(S) and Intuition (N) types align with emotions centered around expectations and reality.

The DISC Personality Model categorizes personalities into four primary types: Dominance (D), Influence (I), Steadiness(S), and Conscientiousness (C).

DISC Types and dual models
1. Dominance (D)
   Dual model Alignment: Self vs. Group/Society
   Typical Emotions: Pride, Anger, Satisfaction, Arrogance
   Factors: Positive/Negative Valence, High Intensity, High Control
   Context: Positive (P) for pride and satisfaction; Negative (N) for anger
2. Influence (I)
   Dual model Alignment: Present vs. Present
   Typical Emotions: Joy, Enthusiasm, Annoyance, Excitement
   Factors: Positive Valence, High Intensity, High Control
   Context: Positive (P) for joy and enthusiasm; Negative (N) for annoyance
3. Steadiness(S)
   Dual model Alignment: Self vs. Others
   Typical Emotions: Compassion, Calm, Empathy, Resentment
   Factors: Positive/Negative Valence, Medium Intensity, Medium/Low Control
   Context: Positive (P) for compassion and empathy; Negative (N) for resentment
4. Conscientiousness (C)
   Dual model Alignment: Self's Standards vs. Actions-Typical Emotions: Guilt, Satisfaction, Integrity, Self-Respect
   Factors: Positive/Negative Valence, Medium Intensity, Medium Control
   Context: Positive (P) for satisfaction and integrity; Negative (N) for guilt
Patterns and Specific Alignments-High Control and Intensity: Dominance (D) aligns with high control and high intensity in Self vs. Group/Society.
   Medium Control: Steadiness(S) and Conscientiousness (C) align with medium control in their respective dual models.
   Positive Valence: Influence (I) aligns with positive valence and high intensity in Present vs. Present.
   Emotional Spectrum: Conscientiousness (C) aligns with emotions related to self-standards and actions.

The HEXACO Personality Model includes six dimensions: Honesty-Humility (H), Emotionality (E), Extraversion (X), Agreeableness (A), Conscientiousness (C), and Openness to Experience (O).

HEXACO Traits and dual models
1. Honesty-Humility (H)
   Dual model Alignment: Self vs. Group/Society
   Typical Emotions: Pride, Shame, Humility, Integrity
   Factors: Positive/Negative Valence, Medium/High Intensity, Medium/High Control
   Context: Positive (P) for pride and integrity; Negative (N) for shame
2. Emotionality (E)
   Dual model Alignment: Future vs. Present
   Typical Emotions: Anxiety, Fear, Hope, Worry
   Factors: Negative Valence, High Intensity, Low Control
   Context: Negative (N) for anxiety and fear; Positive (P) for hope
3. Extraversion (X)
   Dual model Alignment: Present vs. Present
   Typical Emotions: Joy, Happiness, Boredom, Enthusiasm
   Factors: Positive Valence, High Intensity, High Control
   Context: Positive (P) for joy and happiness; Negative (N) for boredom
4. Agreeableness (A)
   Dual model Alignment: Self vs. Others
   Typical Emotions: Compassion, Empathy, Admiration, Resentment
   Factors: Positive/Negative Valence, Medium Intensity, Medium Control
   Context: Positive (P) for compassion and empathy; Negative (N) for resentment
5. Conscientiousness (C)
   Dual model Alignment: Self's Standards vs. Actions
   Typical Emotions: Guilt, Satisfaction, Integrity, Self-Respect
   Factors: Positive/Negative Valence, Medium Intensity, Medium Control
   Context: Positive (P) for satisfaction and integrity; Negative (N) for guilt
6. Openness to Experience (O)
   Dual model Alignment: Self vs. New Information
   Typical Emotions: Curiosity, Fascination, Bewilderment
   Factors: Positive Valence, Medium Intensity, High Control
   Context: Positive (P) for curiosity and fascination; Negative (N) for bewilderment Patterns and Specific Alignments
   High Control and Intensity: Extraversion (X) aligns with high control and high intensity in Present vs. Present.
   Medium Control: Agreeableness (A) and Conscientiousness (C) align with medium control in their respective dual models.
   Negative Valence: Emotionality (E) aligns predominantly with negative valence in Future vs. Present.
   Curiosity and Fascination: Openness to Experience (O) aligns with emotions centered around new information and experiences.

The disclosed model is an expressional model designed to systematically capture and simulate a comprehensive range of emotions. This model's core components—dual models, valence, intensity, control, and context—provide a structured framework for understanding and expressing emotional experiences. The following describes how the disclosed model aligns with established personality classification frameworks to ensure its robustness and accuracy.

The Big Five personality traits—Openness, Conscientiousness, Extraversion, Agreeableness, and Neuroticism—present alignments and potential enhancements/extensions with the dual model approach.
Alignment:
Conscientiousness aligns well with the “Self's Standards vs. Actions” dual model, accurately capturing emotions like guilt, satisfaction, and self-respect.
Extraversion fits seamlessly into the “Present vs. Present” dual model, reflecting emotions such as joy, enthusiasm, and boredom.
Extension:
Neuroticism involves fluctuating perceptions of control, which may not be fully captured by a static control factor in the dual model. To better align this model, introducing a dynamic control factor that accounts for these fluctuations can improve accuracy.
Openness to Experience encompasses a broad range of emotions related to novel stimuli. Expanding the dual model to include more nuanced subcategories for intellectual and aesthetic emotions would better align these models.

The Myers-Briggs Type Indicator (MBTI)'s dichotomies-Extraversion (E) vs. Introversion (I), Sensing(S) vs. Intuition (N), Thinking (T) vs. Feeling (F), and Judging (J) vs. Perceiving (P)—has compatibilities with the disclosed dual model framework.
Alignment:
Judging types align with the “Future vs. Present” dual model due to their future-oriented perspective, capturing emotions like determination and anxiety.
Sensing and Intuition types align with the “Expectations vs. Reality” dual model, accurately reflecting emotions such as surprise and curiosity.
Extension:
Introversion involves internalized emotional experiences that may not manifest with the same intensity outwardly. To better align the dual model, adding an internal-external dimension would capture these introverted emotional expressions.
Thinking and Feeling influence decision-making processes that affect emotional outcomes. Integrating a decision-making context within the dual model would enhance its ability to capture these nuanced emotions.

The DISC Personality Model's primary types—Dominance (D), Influence (I), Steadiness(S), and Conscientiousness (C)—overlaps with the dual model approach.
Alignment:
Steadiness aligns well with the “Self vs. Others” dual model, capturing empathy and compassion.
Conscientiousness is well-represented in the dual model through the “Self's Standards vs. Actions” framework.
Extension:
Dominance might be simplified by the dual model, and thus extensions can better capture the emotional complexity within this type. To better align these models, cross-referencing DISC traits with more granular subcategories in the dual model can achieve greater accuracy.
Influence often exhibits a bias towards positive emotions. Incorporating a bias factor that shifts the balance of positive and negative emotions for highly influential types can better align the dual model.

The HEXACO Personality Model's dimensions-Honesty-Humility (H), Emotionality (E), Extraversion (X), Agreeableness (A), Conscientiousness (C), and Openness to Experience (O)—provide a comprehensive view of personality traits and their emotional correlates.
Alignment:
Extraversion aligns with the “Present vs. Present” dual model, capturing emotions of joy, happiness, and boredom.
Openness to Experience aligns well with the “Self vs. New Information” dual model, reflecting curiosity and fascination.
Extension:
Emotionality involves a wide range of emotions with varying intensities that may be simplified by static intensity factors in the dual model. To better align these models, introducing a gradient scale for intensity can capture the variability in emotionality.
Honesty-Humility involves social contexts that influence emotions like pride and shame. Enhancing the “Self vs. Group/Society” dual model to better capture these social dynamics can improve alignment.

The disclosed dual model aligns with many aspects of established personality classification models, providing a structured and systematic approach to capturing a wide range of emotions. The disclosed dual model can further be enhanced for further alignment:
Dynamic Control: Introducing a dynamic control factor to account for fluctuating perceptions of control, particularly in individuals high in neuroticism or emotionality.
Internal-External Dimension: Adding an internal-external dimension to capture internalized emotional experiences, especially in introverted types.
Decision-Making Context: Integrating decision-making contexts to reflect emotions influenced by thinking vs. feeling preferences.
Bias Factor: Incorporating a bias factor to adjust for the positive or negative emotional skews in specific personality types.
Gradient Intensity Scale: Introducing a gradient scale for intensity to reflect the variability in emotional experiences.

By implementing these additional features, the disclosed dual model can provide a more nuanced and comprehensive framework for understanding and expressing emotions, thereby enhancing its applicability in AI simulations and emotional studies.

The complexity of human emotions often manifests in individuals experiencing multiple emotions simultaneously. These emotions can stem from various sources such as past reflections, present circumstances, future anticipations, and societal perceptions. The disclosed dual model framework captures this multi-faceted nature of emotional experiences, providing a comprehensive and nuanced understanding of how different factors interact to produce specific emotional states.

Emotional experiences are rarely singular or isolated. Instead, individuals can feel a combination of emotions that arise from different contexts and comparisons. For example, one might reflect on a past mistake (regret), feel unease about their current situation, worry about future consequences, and be concerned about societal judgment. Each of these emotions has its own trigger and can coexist, influencing the individual's overall emotional state.

An example scenario with multiple emotional experiences is provided below: Scenario: John reflects on a past mistake, feels unease about his current situation, worries about future implications, and is concerned about societal judgment.
1. Past vs. Present:
   Emotion: Regret
   Factors: Negative Valence, Medium Intensity, Low Control, Negative Context
   Description: John feels regret when comparing a past decision with its current consequences.
2. Present vs. Present:
   Emotion: Unease
   Factors: Negative Valence, Medium Intensity, Medium Control, Negative Context
   Description: John feels unease due to the discomfort of his current situation.
3. Future vs. Present:
   Emotion: Worry
   Factors: Negative Valence, Medium Intensity, Low Control, Negative Context
   Description: John worries about the potential future implications of his current situation.
4. Self vs. Group/Society:
   Emotion: Shame
   Factors: Negative Valence, Medium Intensity, Low Control, Negative Context
   Description: John feels shame due to societal judgment and how he is perceived by others.

The disclosed dual model framework captures the simultaneous experience of multiple emotions by mapping each emotion to its corresponding dual model. This approach allows for a detailed analysis of how different emotional triggers interact and coalesce into a complex emotional state.

As discussed, the disclosed model can be enhanced to refine its accuracy by including an Internal/External Expression factor. In real-world scenarios, individuals often experience emotions internally that do not manifest with the same intensity externally. This discrepancy is particularly noticeable in introverted individuals, who may deeply feel emotions but express them minimally. By incorporating an Internal/External Expression factor, the dual model can capture these nuances more effectively.

The following example illustrates the incorporation of the Internal/External Expression factor.
Jane is an introverted software developer, and receives positive feedback on her project.
   Internal Reaction: Jane feels a deep sense of satisfaction internally, with high intensity.
   Valence: Positive (P)
   Intensity: High (H)
   Control: Medium (M)
   Context: Positive (P)
   Expression: Internal (I)
   External Reaction: Externally, she expresses only a mild smile and a polite “thank you,” with low intensity.
   Valence: Positive (P)
   Intensity: Low (L)
   Control: Medium (M)
   Context: Positive (P)
   Expression: External (E)

By adding this internal-external dimension, the disclosed dual model captures both Jane's profound internal satisfaction and her subtle external expression, providing a more comprehensive and nuanced understanding of her emotional experience.

When extending the disclosed dual model to include empathy or sympathy, it is noted that these extensions involve comparing external models rather than an internal versus external comparison. Empathy and sympathy require understanding and reflecting on the emotional states of others, which inherently involve external situational models.

Example: Tom, a manager, decides whether to promote a team member.
Empathy (External Model): Tom considers the team member's personal circumstances and feels hope for their future success. This consideration compares the future model of the team member's situation with the present.
Dual Model: Future vs. Present
Valence: Positive (P)
Intensity: Medium (M)
Control: Medium (M)
Context: Positive (P)
Sympathy (External Model): Tom feels admiration for the team member's achievements, comparing the team member's accomplishments to others in the organization.
Dual model: Self vs. Others
Valence: Positive (P)
Intensity: Medium (M)
Control: High (H)
Context: Positive (P)

In the above examples, empathy and sympathy are better captured by comparing external models rather than an internal versus external dimension. This approach ensures that the dual model remains focused on accurately reflecting the emotional experiences triggered by external comparisons.

The inclusion of the Internal/External Expression factor can enhance the accuracy of the disclosed model, particularly for introverted individuals. This addition allows the model to capture the depth of internal emotional experiences alongside their external manifestations. When extending the model to include empathy and sympathy, external models are compared rather than introducing an internal versus external comparison. This approach maintains the model's focus and ensures a nuanced understanding of complex emotional experiences.

The disclosed dual model framework systematically captures a wide range of emotional experiences using core components such as dual models, valence, intensity, control, and context. As discussed, the complexity of human emotions and the varying contexts from which can be addressed by the incorporation of sub-dimensions within the existing dual models. Sub-dimensions are specialized categories within broader dual models that capture nuanced emotional experiences arising from specific contexts or dynamics. By incorporating sub-dimensions, the dual model framework can more accurately reflect the intricacies and layered nature of human emotions.

One example that highlights the implementation of sub-dimensions is the interplay between self-expectations and society-expectations within the broader Self vs. Group/Society model. This dynamic is relevant in the context of existing research such as Gretchen Rubin's “The Four Tendencies,” which focuses heavily on how individuals respond to internal and external expectations.

### The Four Tendencies:

Upholder: Meets both internal and external expectations.
Questioner: Meets internal expectations but resists external ones.
Obliger: Meets external expectations but struggles with internal ones.
Rebel: Resists both internal and external expectations.

These tendencies illustrate the importance of capturing emotions that arise from the tension between self-expectations and societal expectations. By introducing a sub-dimension within the Self vs. Group/Society model, these nuanced emotional experiences can accurately be captured.

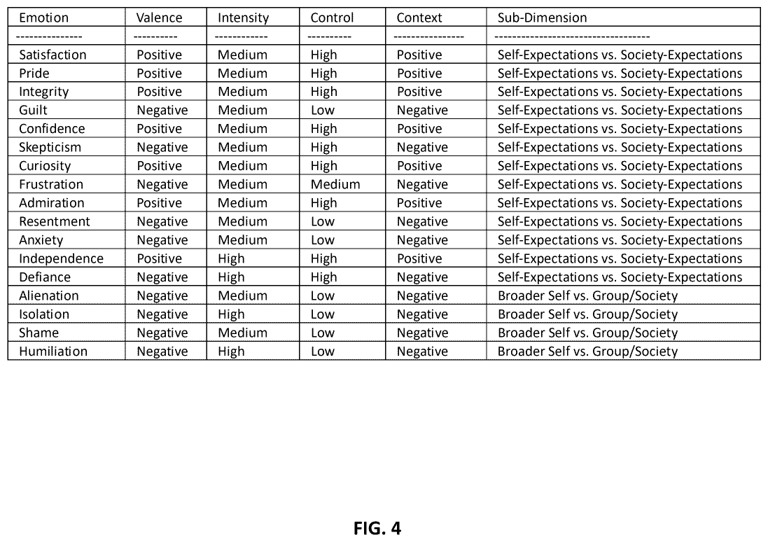

The table shown in FIG. 4 and the following examples illustrate the integration of sub-dimensions in the context of self-expectations vs. society-expectations. The table in FIG. 4 illustrates values for each of a set of emotions, valence, intensity, control, and context, and includes a sub-dimension that expands self vs. group/society to include self-expectations vs. society-expectations.

Scenario 1: Satisfaction in self-expectations vs. society-expectations
Context: An employee feels satisfied when their work meets both personal standards and company expectations.
Valence: Positive (P)
Intensity: Medium (M)
Control: High (H)
Context: Positive (P)
Sub-Dimension: self-expectations vs. society-expectations
   Scenario 2: Pride in self-expectations vs. society-expectations
Context: A student feels proud when their academic achievements are recognized by both themselves and their school.
Valence: Positive (P)
Intensity: Medium (M)
Control: High (H)
Context: Positive (P)
Sub-Dimension: self-expectations vs. society-expectations
   Scenario 3: Alienation in Broader Self vs. Group/Society
Context: A person feels alienated when their beliefs differ significantly from those of their social group.
Valence: Negative (N)
Intensity: Medium (M)
Control: Low (L)
Context: Negative (N)
Sub-Dimension: Broader Self vs. Group/Society

The incorporation of sub-dimensions enables a number of benefits including:
Enhanced Nuance: Sub-dimensions allow for a more nuanced categorization of emotions, capturing specific dynamics such as self vs. societal expectations.
Research-Driven: Incorporating sub-dimensions aligns the dual model framework with existing research and theoretical models, such as “The Four Tendencies,” which emphasize the importance of internal and external expectations.
Comprehensive Coverage: This approach ensures that the dual model framework remains comprehensive, capturing the full spectrum of human emotional experiences without redundancy.

Introducing sub-dimensions within the broader dual models enhances the ability of the framework to capture nuanced emotional experiences. By integrating the self-expectations vs. society-expectations sub-dimension within the self vs. group/society model, the complexities and layered nature of emotions driven by internal and external expectations can accurately be reflected.

The disclosed dual model framework aligns with various personality classification models, offering a structured way to understand their emotional patterns. Each model aligns with particular dual models and factors, enhancing the ability to simulate personality-based emotional responses in AI.

Enhanced Emotional Intelligence: The disclosed model allows AI systems to generate specific, context-sensitive emotional labels, enabling more sophisticated and empathetic interactions. This leads to higher user engagement and satisfaction, improved applications and services where emotional intelligence is critical, such as customer service, virtual assistants, and mental health support.

Context-Aware Interactions: By incorporating a context factor, the disclosed model differentiates emotions based on perceived social impact, allowing AI to tailor responses appropriately. This context-aware capability enhances the relevance and effectiveness of AI interactions, enabling applications and services to be more appealing and user-friendly.

Computational Efficiency: The simplified binary and three-point scales for valence, intensity, and control reduce computational load while maintaining the richness of emotional representation. This efficiency allows for faster processing and real-time emotional analysis, providing a technical advantage compared to more resource-intensive models.

Unique Emotional Labels: Another technical benefit is the ability to generate nuanced and precise emotional terms based on dual model comparisons and emotional factors. This feature ensures that systems can understand and express a broader and more accurate range of human emotions, enhancing user trust and loyalty.

The following example illustrates an application of the emotional model to a complex scenario. To illustrate the practical application of the disclosed emotional model, consider the case of Jack, a fictional character who invested his entire savings into cryptocurrency and lost it all due to a sudden market crash. This event triggers a multifaceted emotional response that can be systematically analyzed using the disclosed model.

Across multiple dual models, Jack experiences emotions characterized by identical factors: Negative Valence (N), High Intensity (H), Low Control (L), and Negative Context (N).
Past vs. Present: Jack feels despair internally (I) and exhibits hopelessness externally (E) when comparing his previous financial stability to his current state of financial loss.
Future vs. Present: He experiences fear (I) and trepidation (E) about his uncertain financial future and potential inability to meet his obligations.
Present vs. Present: Jack feels fury (I) and displays wrath (E) as he is presently furious with himself for making such a risky investment.
Self's Standards vs. Actions: Jack grapples with self-disgust (I) and loathing (E), criticizing himself for acting against his own standards of prudent financial behavior.
Expectations vs. Reality: He is in shock (I) and displays disbelief (E), as the reality of his financial loss starkly contrasts with his expectations of significant gains.
Self vs. Group/Society: Jack feels disgrace (I) and shows shame (E) when considering societal judgments, fearing that others will view him as irresponsible or naive.

These emotions are distinct and arise from different dual models, yet they are generated by the same combination of factors. This demonstrates how identical factors across various dual models can produce a spectrum of specific emotions, contributing to the complexity of human emotional experience.

Furthermore, Jack does not feel despair about others' financial situations (Self vs. Others), nor does he experience fury solely based on his past without the immediate trigger of the present loss. Each emotion is uniquely tied to its respective dual model, illustrating the model's ability to differentiate emotional states based on cognitive evaluations.

This example illustrates the model's capacity to capture nuanced emotional responses resulting from a single event. By systematically mapping these emotions, artificial intelligence systems can better interpret and simulate complex human emotional states, enhancing empathetic interactions and decision-making processes.

The various figures (which might be referred to herein as a “FIG.” or “FIGs.”) provide additional details regarding the disclosed embodiments. The figures show, by way of illustration, specific configurations or examples. Like numerals represent like or similar elements throughout the FIGs. In the FIGs., the left-most digit(s) of a reference number generally identifies the figure in which the reference number first appears. References made to individual items of a plurality of items can use a reference number with another number included within a parenthetical (and/or a letter without a parenthetical) to refer to each individual item. Generic references to the items might use the specific reference number without the sequence of letters. The drawings are not drawn to scale.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings. Furthermore, the claimed subject matter is not limited to implementations that solve any or all disadvantages noted in any part of this disclosure.

It should be appreciated that various aspects of the subject matter described briefly above and in further detail below can be implemented as a hardware device, a computer-implemented method, a computer-controlled apparatus or device, a computing system, or an article of manufacture, such as a computer storage medium. While the subject matter described herein is presented in the general context of program modules that execute on one or more computing devices, those skilled in the art will recognize that other implementations can be performed in combination with other types of program modules. Generally, program modules include routines, programs, components, data structures, and other types of structures that perform particular tasks or implement particular abstract data types.

Those skilled in the art will also appreciate that aspects of the subject matter described herein can be practiced on or in conjunction with other computer system configurations beyond those specifically described herein, including multiprocessor systems, microprocessor-based or programmable consumer electronics, AR, VR, and MR devices, video game devices, handheld computers, smartphones, smart televisions, self-driving vehicles, smart watches, c-readers, tablet computing devices, special-purpose hardware devices, network appliances, and the others.

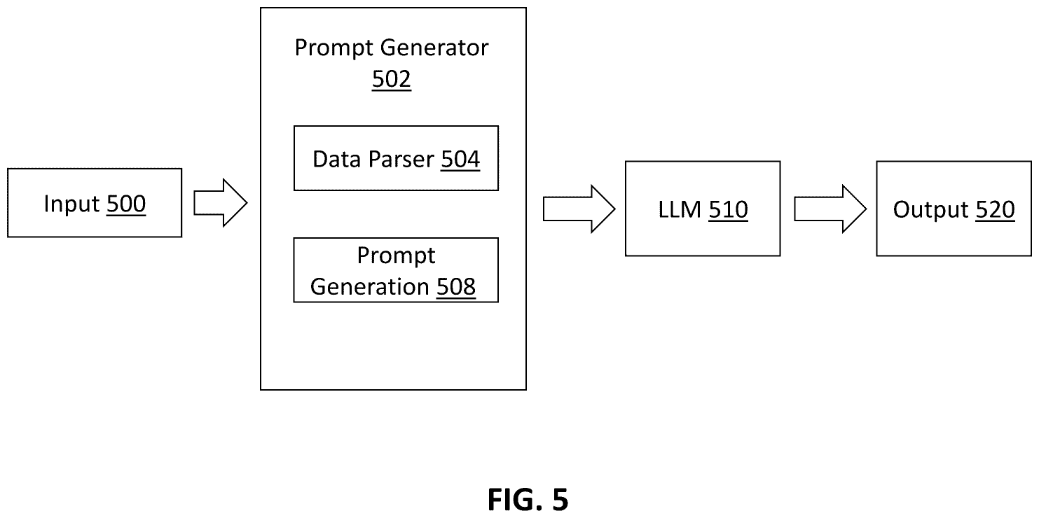

With reference to FIG. 5, illustrated is an example system for using an LLM to analyze user inputs. A prompt system 502 receives new input data 500. A data parser 504 takes the input data to identify content and structure of the input data 500 and provides the parsed data to a prompt generator 508 which generates a prompt for input to a LLM 510. The prompt can include instructions to incorporate the disclosed models to identify affective states of a user. LLM 510 uses the prompt to generate an output 520. In some embodiments, one language model can be prompted to provide information that can be used to annotate a prompt to another language model. For example, a language model can be prompted to identify which emotions are indicated by a given input. The identified emotions can then be used to append a prompt or modify a prompt that is input to another language model. In some embodiments, the LLM 510 (or other model) can be tuned to incorporate aspects of the disclosed embodiments.

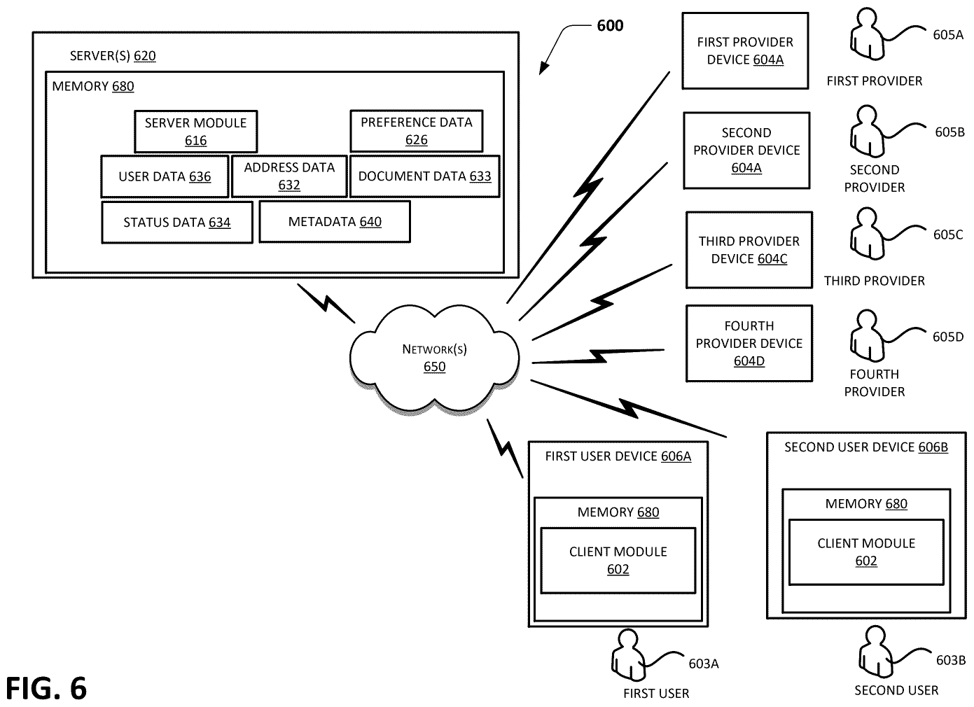

FIG. 6 is a block diagram showing aspects of one example environment 600, also referred to herein as a “system 600,” disclosed herein for providing management of emails. In one illustrative example, the example environment 600 can include one or more servers 620, one or more networks 650, one or more user devices 606A-606B (collectively “user devices 606”), one or more provider devices 604A-604D (collectively “provider devices 604”), and one or more resources 606A-606E (collectively “resources 606”). The user devices 606 can be utilized for interaction with one or more users 603A-603B (collectively “users 603”), and the provider devices 604 can be utilized for interaction with one or more service providers 605A-605D (collectively “service providers 605”). This example is provided for illustrative purposes and is not to be construed as limiting. It can be appreciated that the example environment 600 can include any number of devices, users, providers, and/or any number of servers 620.

For illustrative purposes, the service providers 605 can be a company, person, or any type of entity capable of providing services or products for the users 603, which can also be a company, person or other entity. For illustrative purposes, the service providers 605 and the users 603 can be generically and individually referred to herein as “users.” In some configurations, a data object may include one or more messages. Contextual data can be analyzed to determine one or more messages that can be updated dynamically.

The user devices 606, provider devices 604, servers 620 and/or any other computer configured with the features disclosed herein can be interconnected through one or more local and/or wide area networks, such as the network 650. In addition, the computing devices can communicate using any technology, such as BLUETOOTH, WIFI, WIFI DIRECT, NFC or any other suitable technology, which may include light-based, wired, or wireless technologies. It should be appreciated that many more types of connections may be utilized than described herein.

A user device 606 or a provider device 604 (collectively “computing devices”) can operate as a stand-alone device, or such devices can operate in conjunction with other computers, such as the one or more servers 620. Individual computing devices can be in the form of a personal computer, mobile phone, tablet, wearable computer, including a head-mounted display (HMD) or watch, or any other computing device having components for interacting with one or more users and/or remote computers. In one illustrative example, the user device 606 and the provider device 604 can include a local memory 680, also referred to herein as a “computer-readable storage medium” or “non-transitory computer-readable storage medium” configured to store data, such as a client module 602 and other contextual data described herein.

The servers 620 may be in the form of a personal computer, server farm, large-scale system or any other computing system having components for processing, coordinating, collecting, storing, and/or communicating data between one or more computing device. In one illustrative example, the servers 620 can include a local memory 680, also referred to herein as a “computer-readable storage medium,” configured to store data, such as a server module 616 and other data described herein. The servers 620 can also include components and services, such as the application services and shown in FIG. 6, for providing, receiving, and processing email data and executing one or more aspects of the techniques described herein. As will be described in more detail herein, any suitable module may operate in conjunction with other modules or devices to implement aspects of the techniques disclosed herein.

In some configurations, an application programming interface (API) exposes an interface through which an operating system and application programs executing on the computing device can enable the functionality disclosed herein. Through the use of this data interface and other interfaces, the operating system and application programs can communicate and process contextual data and modify scheduling data as described herein.

The user data 636 can include various data for the users 603 and the providers 605. The user data 636 can include communication information such as a email address, job title, or other information. The user data 636 can be stored on the server 620, user device 606, provider device 604, or any suitable computing device, which may include a Web-based service.

The address data 632 may include address information for the user's contacts. The address data 632 can also be based on user data 636. These examples are provided for illustrative purposes and are not to be construed as limiting. The preference data 626 can include user-defined preferences or provider-defined preferences. Other data include document data 633, status data 634, and metadata 640.

To enable aspects of the techniques disclosed herein, one or more computing devices of FIG. 6 can be configured to generate data defining one or more live updates in response to detecting the presence of a condition. The implementations can include obtaining contextual data from a plurality of resources.

One or more computing devices can be configured to identify a pattern of the contextual data indicating a presence of a condition that affects one or more aspects of an email.

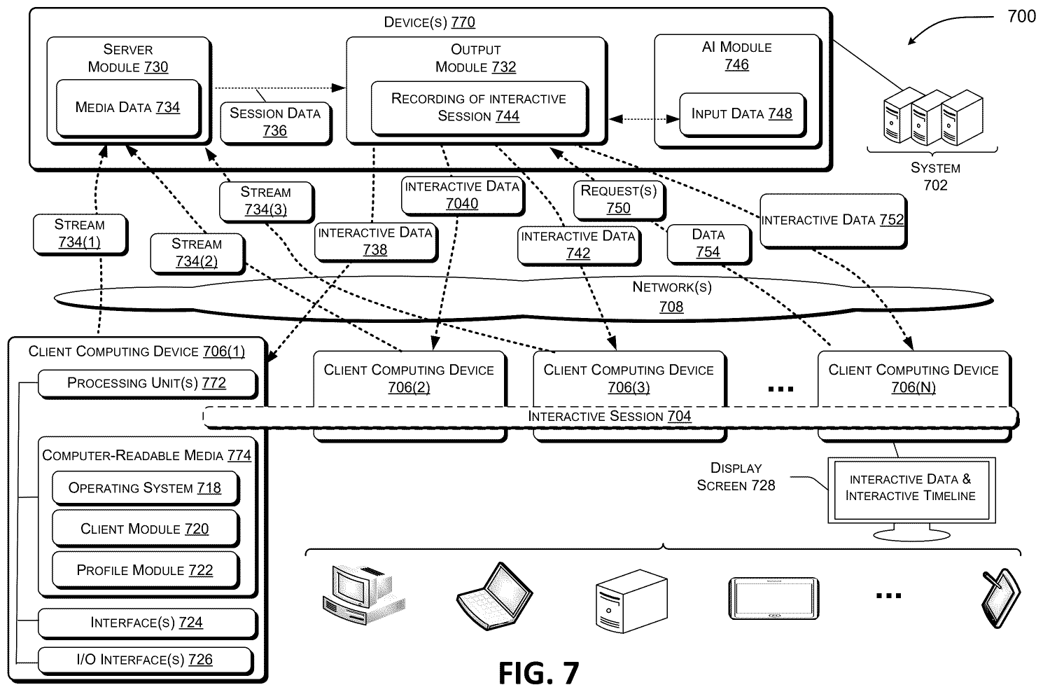

FIG. 7 is a diagram illustrating an example environment 700 in which a system can operate to generate information for an interactive session 704 and to save and edit content. In this example, an interactive session 704 is implemented between a number of client computing devices 706(1) through 706(N) (where N is a positive integer number having a value of two or greater). The client computing devices 706(1) through 706(N) enable users to participate in the interactive session 704. In this example, the interactive session 704 is hosted, over one or more network(s) 708, by the system 702. That is, the system 702 can provide a service that enables users of the client computing devices 706(1) through 706(N) to participate in the interactive session 704 (e.g., via a live viewing and/or a recorded viewing). Consequently, a “participant” to the interactive session 704 can comprise a user and/or a client computing device (e.g., multiple users may be in a conference room participating in a interactive session via the use of a single client computing device), each of which can communicate with other participants. As an alternative, the interactive session 704 can be hosted by one of the client computing devices 706(1) through 706(N) utilizing peer-to-peer technologies.

In examples described herein, client computing devices 706(1) through 706(N) participating in an interactive session 704 are configured to receive and render for display, on a user interface of a display screen, interactive data. The interactive data can comprise a collection of various instances, or streams, of content. For example, an individual stream of content can comprise media data associated with a video feed (e.g., audio and visual data that capture the appearance and speech of a user participating in the interactive session). Another example of an individual stream of content can comprise media data that includes a file displayed on a display screen along with audio data that captures the speech of a user. Accordingly, the various streams of content within the teleconference data enable a remote meeting to be facilitated between a group of people and the sharing of content within the group of people.

The system 702 includes device(s) 770. The device(s) 770 and/or other components of the system 702 can include distributed computing resources that communicate with one another and/or with the client computing devices 706(1) through 706(N) via the one or more network(s) 708. In some examples, the system 702 may be an independent system that is tasked with managing aspects of one or more interactive sessions such as interactive session 704. As an example, the system 702 may be managed by entities such as SLACK, WEBEX, GOTOMEETING, GOOGLE HANGOUTS, etc.

Network(s) 708 may include, for example, public networks such as the Internet, private networks such as an institutional and/or personal intranet, or some combination of private and public networks. Network(s) 708 may also include any type of wired and/or wireless network, including but not limited to local area networks (“LANs”), wide area networks (“WANs”), satellite networks, cable networks, Wi-Fi networks, WiMax networks, mobile communications networks (e.g., 3G, 4G, and so forth) or any combination thereof. Network(s) 708 may utilize communications protocols, including packet-based and/or datagram-based protocols such as Internet protocol (“IP”), transmission control protocol (“TCP”), user datagram protocol (“UDP”), or other types of protocols. Moreover, network(s) 708 may also include a number of devices that facilitate network communications and/or form a hardware basis for the networks, such as switches, routers, gateways, access points, firewalls, base stations, repeaters, backbone devices, and the like.

In some examples, network(s) 708 may further include devices that enable connection to a wireless network, such as a wireless access point (“WAP”). Examples support connectivity through WAPs that send and receive data over various electromagnetic frequencies (e.g., radio frequencies), including WAPs that support Institute of Electrical and Electronics Engineers (“IEEE”) 802.11 standards (e.g., 802.11g, 802.11n, and so forth), and other standards.

In various examples, device(s) 770 may include one or more computing devices that operate in a cluster or other grouped configuration to share resources, balance load, increase performance, provide fail-over support or redundancy, or for other purposes. For instance, device(s) 770 may belong to a variety of classes of devices such as traditional server-type devices, desktop computer-type devices, and/or mobile-type devices. Thus, although illustrated as a single type of device—a server-type device—device(s) 770 may include a diverse variety of device types and are not limited to a particular type of device. Device(s) 770 may represent, but are not limited to, server computers, desktop computers, web-server computers, personal computers, mobile computers, laptop computers, tablet computers, or any other sort of computing device.

A client computing device (e.g., one of client computing device(s) 706(1) through 706(N)) (each of which are also referred to herein as a “data processing system”) may belong to a variety of classes of devices, which may be the same as, or different from, device(s) 770, such as traditional client-type devices, desktop computer-type devices, mobile-type devices, special purpose-type devices, embedded-type devices, and/or wearable-type devices. Thus, a client computing device can include, but is not limited to, a desktop computer, a game console and/or a gaming device, a tablet computer, a personal data assistant (“PDA”), a mobile phone/tablet hybrid, a laptop computer, a telecommunication device, a computer navigation type client computing device such as a satellite-based navigation system including a global positioning system (“GPS”) device, a wearable device, a virtual reality (“VR”) device, an augmented reality (AR) device, an implanted computing device, an automotive computer, a network-enabled television, a thin client, a terminal, an Internet of Things (“IoT”) device, a work station, a media player, a personal video recorders (“PVR”), a set-top box, a camera, an integrated component (e.g., a peripheral device) for inclusion in a computing device, an appliance, or any other sort of computing device. Moreover, the client computing device may include a combination of the earlier listed examples of the client computing device such as, for example, desktop computer-type devices or a mobile-type device in combination with a wearable device, etc.

Client computing device(s) 706(1) through 706(N) of the various classes and device types can represent any type of computing device having one or more processing unit(s) 772 operably connected to computer-readable media 774 such as via a bus, which in some instances can include one or more of a system bus, a data bus, an address bus, a PCI bus, a Mini-PCI bus, and any variety of local, peripheral, and/or independent buses.

Executable instructions stored on computer-readable media 774 may include, for example, an operating system 718, a client module 720, a profile module 722, and other modules, programs, or applications that are loadable and executable by processing units(s) 772.

Client computing device(s) 706(1) through 706(N) may also include one or more interface(s) 724 to enable communications between client computing device(s) 706(1) through 706(N) and other networked devices, such as device(s) 770, over network(s) 708. Such network interface(s) 724 may include one or more network interface controllers (NICs) or other types of transceiver devices to send and receive communications and/or data over a network. Moreover, a client computing device 706(1) can include input/output (“I/O”) interfaces 726 that enable communications with input/output devices such as user input devices including peripheral input devices (e.g., a game controller, a keyboard, a mouse, a pen, a voice input device such as a microphone, a touch input device, a gestural input device, and the like) and/or output devices including peripheral output devices (e.g., a display, a printer, audio speakers, a haptic output device, and the like). FIG. 7 illustrates that client computing device 706(N) is in some way connected to a display device (e.g., a display screen 728), which can display the interactive timeline for the interactive session 704, as shown.

In the example environment 700 of FIG. 7, client computing devices 706(1) through 706(N) may use their respective client modules 720 to connect with one another and/or other external device(s) in order to participate in the interactive session 704. For instance, a first user may utilize a client computing device 706(1) to communicate with a second user of another client computing device 706(2). When executing client modules 720, the users may share data, which may cause the client computing device 706(1) to connect to the system 702 and/or the other client computing devices 706(2) through 706(N) over the network(s) 708.

The client computing device(s) 706(1) through 706(N) may use their respective profile module 722 to generate participant profiles and provide the participant profiles to other client computing devices and/or to the device(s) 770 of the system 702. A participant profile may include one or more of an identity of a user or a group of users (e.g., a name, a unique identifier (“ID”), etc.), user data such as personal data, machine data such as location (e.g., an IP address, a room in a building, etc.) and technical capabilities, etc. Participant profiles may be utilized to register participants for interactive sessions.

As shown in FIG. 7, the device(s) 770 of the system 702 includes a server module 730 and an output module 732. The server module 730 is configured to receive, from individual client computing devices such as client computing devices 706(1) through 706(3), media streams 734(1) through 734(3). As described above, media streams can comprise a video feed (e.g., audio and visual data associated with a user), audio data which is to be output (e.g., an audio only experience in which video data of the user is not transmitted), text data (e.g., text messages), file data and/or screen sharing data (e.g., a document, a slide deck, an image, a video displayed on a display screen, etc.), and so forth. Thus, the server module 730 is configured to receive a collection of various media streams 734(1) through 734(3) (the collection being referred to herein as media data 734). In some scenarios, not all the client computing devices that participate in the interactive session 704 provide a media stream. For example, a client computing device may only be a consuming, or a “listening”, device such that it only receives content associated with the interactive session 704 but does not provide any content to the interactive session 704.

The server module 730 is configured to generate session data 736 based on the media data 734. In various examples, the server module 730 can select aspects of the media data 734 that are to be shared with the participating client computing devices 706(1) through 706(N). Consequently, the server module 730 is configured to pass the session data 736 to the output module 732 and the output module 732 may communicate teleconference data to the client computing devices 706(1) through 706(3). As shown, the output module 732 transmits teleconference data 738 to client computing device 706(1), transmits teleconference data 7040 to client computing device 706(2), and transmits interactive data 742 to client computing device 706(3). The interactive data transmitted to the client computing devices can be the same or can be different (e.g., positioning of streams of content within a user interface may vary from one device to the next). The output module 732 is also configured to record the interactive session (e.g., a version of the interactive data) and to maintain a recording of the interactive session 744.

The device(s) 770 can also include an AI module 746, and in various examples, the AI module 746 is configured to manage input data 748 in the session data 736 and/or events relevant to interactive session 744.

A client computing device such as client computing device 706(N) can provide a request 750 to view a recording of the interactive session 704. In response, the output module 732 can provide interactive data and interactive data 752 to be displayed on a display screen 728 associated with the client computing device 706(N). The teleconference data transmitted to client computing device 706(N) comprises previously recorded content of the interactive session 704. As further described herein, a user of client computing device 706(N) can provide input(s) to add supplemental recorded content to the interactive session 704 and/or to the interactive timeline, and data 754 associated with the supplemental recorded content can be transmitted from client computing device 706(N) to the system 702 so that the recording of the interactive session 744 and the interactive timeline can be updated with the supplemental recorded content. This enables other participants (e.g., users of client computing devices 706(1) through 706(3)) to consume or view the supplemental recorded content after the live viewing of the interactive session has already ended. An improved human-computer interface (“HCl”) is disclosed herein for interacting with representations of emails and email content. In some embodiments, the email information may be presented in conjunction with a communications platform such as a videoconferencing platform. Such a system may be referred to as an interactive email system.

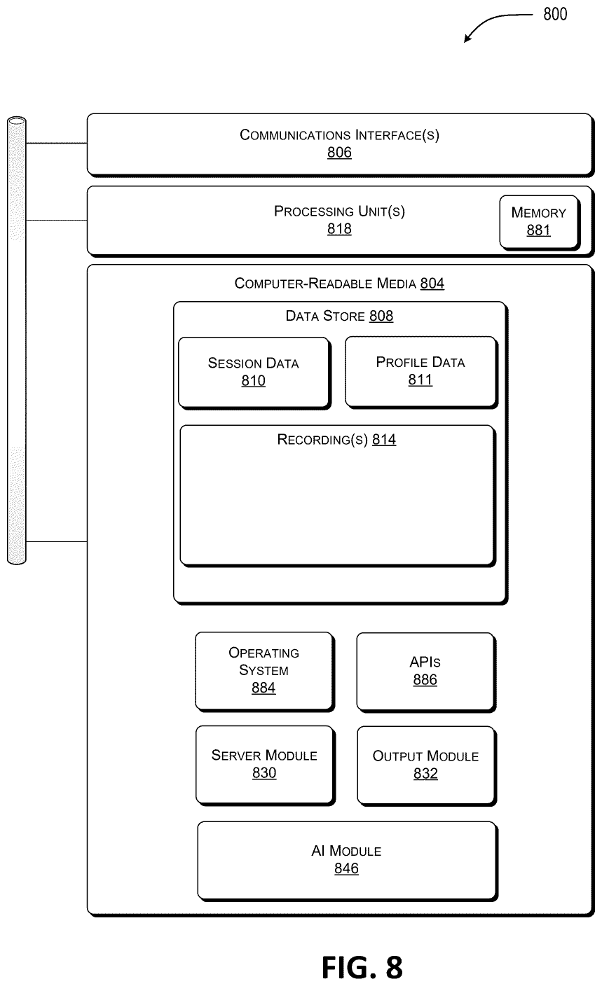

FIG. 8 illustrates a diagram that shows example components of an example device 800 configured to render and update email data. The device 800 may represent one of device(s), or in other examples a client computing device, where the device 800 includes one or more processing unit(s) 818, computer-readable media 804, and communication interface(s) 806. The components of the device 800 are operatively connected, for example, via a bus, which may include one or more of a system bus, a data bus, an address bus, a PCI bus, a Mini-PCI bus, and any variety of local, peripheral, and/or independent buses.

As utilized herein, processing unit(s), such as the processing unit(s) 818, may represent, for example, a CPU-type processing unit, a GPU-type processing unit, a field-programmable gate array (“FPGA”), another class of digital signal processor (“DSP”), or other hardware logic components that may, in some instances, be driven by a CPU. For example, and without limitation, illustrative types of hardware logic components that may be utilized include Application-Specific Integrated Circuits (“ASICs”), Application-Specific Standard Products (“ASSPs”), System-on-a-Chip Systems (“SOCs”), Complex Programmable Logic Devices (“CPLDs”), etc.

As utilized herein, computer-readable media, such as computer-readable media 804, may store instructions executable by the processing unit(s). The computer-readable media may also store instructions executable by external processing units such as by an external CPU, an external GPU, and/or executable by an external accelerator, such as an FPGA type accelerator, a DSP type accelerator, or any other internal or external accelerator. In various examples, at least one CPU, GPU, and/or accelerator is incorporated in a computing device, while in some examples one or more of a CPU, GPU, and/or accelerator is external to a computing device.

Computer-readable media may include computer storage media and/or communication media. Computer storage media may include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random-access memory (“RAM”), static random-access memory (“SRAM”), dynamic random-access memory (“DRAM”), phase change memory (“PCM”), read-only memory (“ROM”), erasable programmable read-only memory (“EPROM”), electrically erasable programmable read-only memory (“EEPROM”), flash memory, compact disc read-only memory (“CD-ROM”), digital versatile disks (“DVDs”), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer storage media, communication media may embody computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se.

Communication interface(s) 806 may represent, for example, network interface controllers (“NICs”) or other types of transceiver devices to send and receive communications over a network.

In the illustrated example, computer-readable media 804 includes a data store 808. In some examples, data store 808 includes data storage such as a database, data warehouse, or other type of structured or unstructured data storage. In some examples, data store 808 includes a corpus and/or a relational database with one or more tables, indices, stored procedures, and so forth to enable data access including one or more of hypertext markup language (“HTML”) tables, resource description framework (“RDF”) tables, web ontology language (“OWL”) tables, and/or extensible markup language (“XML”) tables, for example.

The data store 808 may store data for the operations of processes, applications, components, and/or modules stored in computer-readable media 804 and/or executed by processing unit(s) 818 and/or accelerator(s). For instance, in some examples, data store 808 may store session data 810, profile data 811 (e.g., associated with a participant profile), and/or other data. The session data 810 can include a total number of participants (e.g., users and/or client computing devices) in an interactive session, and activity that occurs in the interactive session, and/or other data related to when and how the interactive session is conducted or hosted. The data store 808 can also include recording(s) 814 of interactive session(s).

Alternately, some or all of the above-referenced data can be stored on separate memories 881 on board one or more processing unit(s) 818 such as a memory on board a CPU-type processor, a GPU-type processor, an FPGA-type accelerator, a DSP-type accelerator, and/or another accelerator. In this example, the computer-readable media 804 also includes operating system 884 and application programming interface(s) 886 configured to expose the functionality and the data of the device 800 to other devices. Additionally, the computer-readable media 804 includes one or more modules such as the server module 830, the output module 832, and the AI module 846, although the number of illustrated modules is just an example, and the number may vary higher or lower. That is, functionality described herein in association with the illustrated modules may be performed by a fewer number of modules or a larger number of modules on one device or spread across multiple devices.

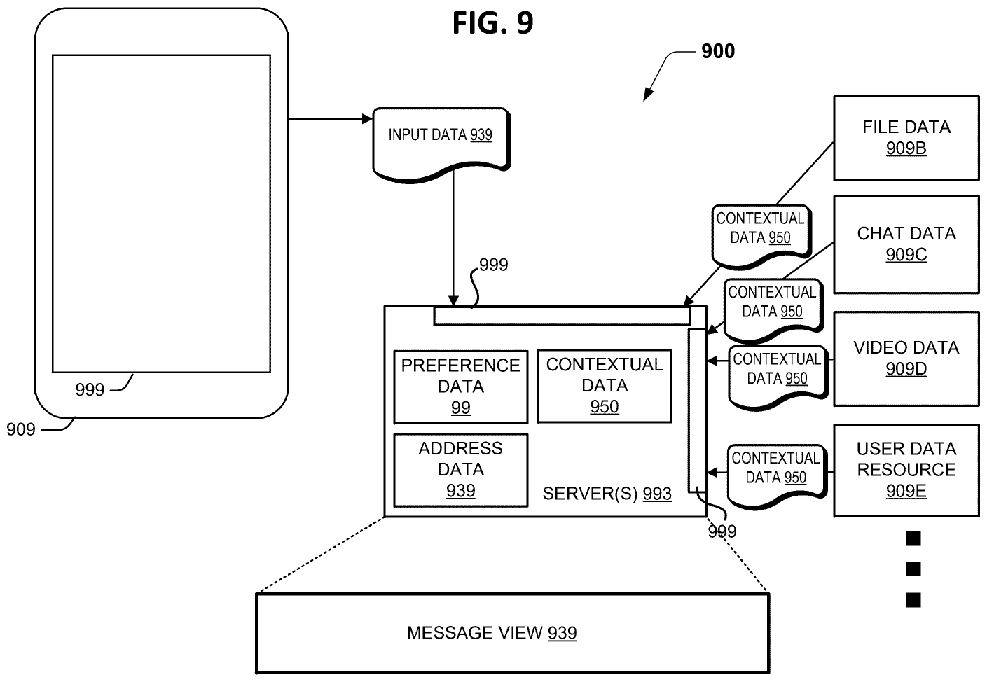

FIG. 9 illustrates aspects of the system 900 that provide a framework for several example scenarios utilizing the techniques disclosed herein. More specifically, this block diagram of the system 900 shows an illustrative example of the server 993 receiving input data 939 defining a user input. The server 993 is also storing input data 939 defining a number of inputs for a user and preference data 99. The server 993 also receives contextual data 950 from a number of resources 909B-909E, as well as other resources described herein. To illustrate aspects of the examples described below, the user device 909 is displaying a user interface (UI) 999 showing a message view.

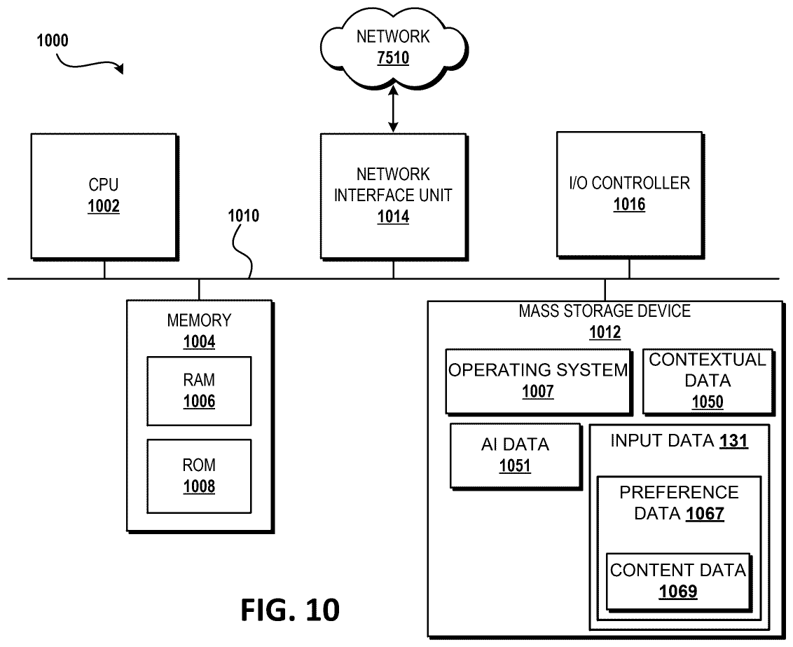

FIG. 10 shows additional details of an example computer architecture 1000 for a computer, such as any of the computing devices depicted in FIGS. 1-14, capable of executing the program components described herein. Thus, the computer architecture 1000 illustrated in FIG. 10 illustrates an architecture for a server computer, mobile phone, a PDA, a smart phone, a desktop computer, a netbook computer, a tablet computer, and/or a laptop computer. The computer architecture 1000 may be utilized to execute any aspects of the software components presented herein.

The computer architecture 1000 illustrated in FIG. 10 includes a central processing unit 1002 (“CPU”), a system memory 1004, including a random access memory 1006 (“RAM”) and a read-only memory (“ROM”) 1008, and a system bus 1010 that couples the memory 1004 to the CPU 1002. A basic input/output system containing the basic routines that help to transfer information between elements within the computer architecture 1000, such as during startup, is stored in the ROM 1008. The computer architecture 1000 further includes a mass storage device 1012 for storing an operating system 1007, data, such as the contextual data 1050, AI data 1051, input data 131, preference data 1067, content data 1069, and one or more application programs (not depicted in FIG. 10).

The mass storage device 1012 is connected to the CPU 1002 through a mass storage controller (not shown) connected to the bus 1010. The mass storage device 1012 and its associated computer-readable media provide non-volatile storage for the computer architecture 1000. Although the description of computer-readable media contained herein refers to a mass storage device, such as a solid state drive, a hard disk or CD-ROM drive, it should be appreciated by those skilled in the art that computer-readable media can be any available computer storage media or communication media that can be accessed by the computer architecture 1000.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 1000. For purposes the claims, the phrase “computer storage medium,” “computer-readable storage medium” and variations thereof, does not include waves, signals, and/or other transitory and/or intangible communication media, per se.

According to various configurations, the computer architecture 1000 may operate in a networked environment using logical connections to remote computers through the network 7510 and/or another network (not shown). The computer architecture 1000 may connect to the network 7510 through a network interface unit 1014 connected to the bus 1010. It should be appreciated that the network interface unit 1014 also may be utilized to connect to other types of networks and remote computer systems. The computer architecture 1000 also may include an input/output controller 1016 for receiving and processing input from a number of other devices, including a keyboard, mouse, or electronic stylus (not shown in FIG. 10). Similarly, the input/output controller 1016 may provide output to a display screen, a printer, or other type of output device (also not shown in FIG. 10).

It should be appreciated that the software components described herein may, when loaded into the CPU 1002 and executed, transform the CPU 1002 and the overall computer architecture 1000 from a general-purpose computing system into a special-purpose computing system customized to facilitate the functionality presented herein. The CPU 1002 may be constructed from any number of transistors or other discrete circuit elements, which may individually or collectively assume any number of states. More specifically, the CPU 1002 may operate as a finite-state machine, in response to executable instructions contained within the software modules disclosed herein. These computer-executable instructions may transform the CPU 1002 by specifying how the CPU 1002 transitions between states, thereby transforming the transistors or other discrete hardware elements constituting the CPU 1002.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 1000 in order to store and execute the software components presented herein. It also should be appreciated that the computer architecture 1000 may include other types of computing devices, including hand-held computers, embedded computer systems, personal digital assistants, and other types of computing devices known to those skilled in the art. It is also contemplated that the computer architecture 1000 may not include all of the components shown in FIG. 10, may include other components that are not explicitly shown in FIG. 10, or may utilize an architecture completely different than that shown in FIG. 10.

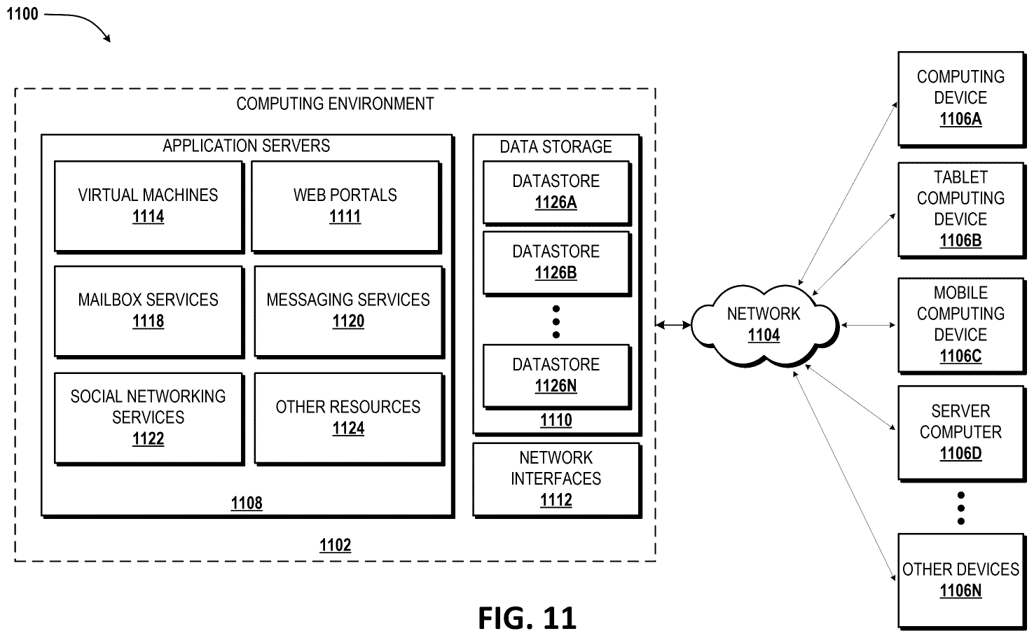

FIG. 11 depicts an illustrative distributed computing environment 1100 capable of executing the software components described herein for providing contextually-aware insights into email messages. Thus, the distributed computing environment 1100 illustrated in FIG. 11 can be utilized to execute any aspects of the software components presented herein. For example, the distributed computing environment 1100 can be utilized to execute aspects of the software components described herein.

According to various implementations, the distributed computing environment 1100 includes a computing environment 1102 operating on, in communication with, or as part of the network 1104. The network 1104 may be or may include the networks described above. The network 1104 also can include various access networks. One or more client devices 1106A-1106N (hereinafter referred to collectively and/or generically as “clients 1106”) can communicate with the computing environment 1102 via the network 1104 and/or other connections (not illustrated in FIG. 11). In one illustrated configuration, the clients 1106 include a computing device 1106A such as a laptop computer, a desktop computer, or other computing device; a slate or tablet computing device (“tablet computing device”) 1106B; a mobile computing device 1106C such as a mobile telephone, a smart phone, or other mobile computing device; a server computer 1106D; and/or other devices 1106N. It should be understood that any number of clients 1106 can communicate with the computing environment 1102. Two example computing architectures for the clients 1106 are illustrated and described herein with reference to FIGS. 1-15. It should be understood that the illustrated clients 1106 and computing architectures illustrated and described herein are illustrative, and should not be construed as being limited in any way.

In the illustrated configuration, the computing environment 1102 includes application servers 1108, data storage 1110, and one or more network interfaces 1112. According to various implementations, the functionality of the application servers 1108 can be provided by one or more server computers that are executing as part of, or in communication with, the network 1104. The application servers 1108 can host various services, virtual machines, portals, and/or other resources. In the illustrated configuration, the application servers 1108 host one or more virtual machines 1114 for hosting applications or other functionality. According to various implementations, the virtual machines 1114 host one or more applications and/or software modules for providing contextually-aware insights into email messages. It should be understood that this configuration is illustrative, and should not be construed as being limiting in any way. The application servers 1108 also host or provide access to one or more portals, link pages, Web sites, and/or other information (“Web portals”) 1111.

According to various implementations, the application servers 1108 also include one or more mailbox services 1118 and one or more messaging services 1120. The mailbox services 1118 can include electronic mail (“email”) services. The mailbox services 1118 also can include various personal information management (“PIM”) services including, but not limited to, calendar services, contact management services, collaboration services, and/or other services. The messaging services 1120 can include, but are not limited to, instant messaging services, chat services, forum services, and/or other communication services.

The application servers 1108 also may include one or more social networking services 1122. The social networking services 1122 can include various social networking services including, but not limited to, services for sharing or posting status updates, instant messages, links, photos, videos, and/or other information; services for commenting or displaying interest in articles, products, blogs, or other resources; and/or other services. In some configurations, the social networking services 1122 are provided by or include the FACEBOOK social networking service, the LINKEDIN professional networking service, the MYSPACE social networking service, the FOURSQUARE geographic networking service, the YAMMER office colleague networking service, and the like. In other configurations, the social networking services 1122 are provided by other services, sites, and/or providers that may or may not be explicitly known as social networking providers. For example, some web sites allow users to interact with one another via email, chat services, and/or other means during various activities and/or contexts such as reading published articles, commenting on goods or services, publishing, collaboration, gaming, and the like. Examples of such services include, but are not limited to, the WINDOWS LIVE service and the XBOX LIVE service from Microsoft Corporation in Redmond, Washington. Other services are possible and are contemplated.

The social networking services 1122 also can include commenting, blogging, and/or micro blogging services. Examples of such services include, but are not limited to, the YELP commenting service, the KUDZU review service, the OFFICETALK enterprise micro blogging service, the TWITTER messaging service, the GOOGLE BUZZ service, and/or other services. It should be appreciated that the above lists of services are not exhaustive and that numerous additional and/or alternative social networking services 1122 are not mentioned herein for the sake of brevity. As such, the above configurations are illustrative, and should not be construed as being limited in any way. According to various implementations, the social networking services 1122 may host one or more applications and/or software modules for providing the functionality described herein for providing contextually-aware insights into email messages. For instance, any one of the application servers 1108 may communicate or facilitate the functionality and features described herein. For instance, a social networking application, mail client, messaging client or a browser running on a phone or any other client 1106 may communicate with a networking service 1122 and facilitate the functionality, even in part, described above with respect to FIGS. 1-15.

As shown in FIG. 11, the application servers 1108 also can host other services, applications, portals, and/or other resources (“other resources”) 1124. The other resources 1124 can include, but are not limited to, document sharing, rendering or any other functionality. It thus can be appreciated that the computing environment 1102 can provide integration of the concepts and technologies disclosed herein provided herein with various mailbox, messaging, social networking, and/or other services or resources.

As mentioned above, the computing environment 1102 can include the data storage 1110. According to various implementations, the functionality of the data storage 1110 is provided by one or more databases operating on, or in communication with, the network 1104. The functionality of the data storage 1110 also can be provided by one or more server computers configured to host data for the computing environment 1102. The data storage 1110 can include, host, or provide one or more real or virtual data stores 1126A-1126N (hereinafter referred to collectively and/or generically as “datastores 1126”). The datastores 1126 are configured to host data used or created by the application servers 1108 and/or other data. Although not illustrated in FIG. 11, the datastores 1126 also can host or store web page documents, word documents, presentation documents, data structures, algorithms for execution by a recommendation engine, and/or other data utilized by any application program or another module. Aspects of the datastores 1126 may be associated with a service for storing files.

The computing environment 1102 can communicate with, or be accessed by, the network interfaces 1112. The network interfaces 1112 can include various types of network hardware and software for supporting communications between two or more computing devices including, but not limited to, the clients 1106 and the application servers 1108. It should be appreciated that the network interfaces 1112 also may be utilized to connect to other types of networks and/or computer systems.

It should be understood that the distributed computing environment 1100 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 1100 provides the software functionality described herein as a service to the clients 1106. It should be understood that the clients 1106 can include real or virtual machines including, but not limited to, server computers, web servers, personal computers, mobile computing devices, smart phones, and/or other devices. As such, various configurations of the concepts and technologies disclosed herein enable any device configured to access the distributed computing environment 1100 to utilize the functionality described herein for providing contextually-aware insights into email messages, among other aspects.

It should be appreciated that the above-described subject matter may be implemented as a computer-controlled apparatus, a computer process, a computing system, or as an article of manufacture such as a computer-readable storage medium. The operations of the example methods are illustrated in individual blocks and summarized with reference to those blocks. The methods are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations.

Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s) such as one or more internal or external CPUs or GPUs, and/or one or more pieces of hardware logic such as field-programmable gate arrays (“FPGAs”), digital signal processors (“DSPs”), or other types of accelerators.

All of the methods and processes described above may be embodied in, and fully automated via, software code modules executed by one or more general purpose computers or processors. The code modules may be stored in any type of computer-readable storage medium or other computer storage device, such as those described below. Some or all of the methods may alternatively be embodied in specialized computer hardware, such as that described below.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art.

It is to be appreciated that conditional language used herein such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

It should also be appreciated that many variations and modifications may be made to the above-described examples, the elements of which are to be understood as being among other acceptable examples. All such modifications and variations are intended to be included herein within the scope of this disclosure and protected by the following claims.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

Among many other technical benefits, the technologies herein enable more efficient use of computing resources such as processor cycles, memory, network bandwidth, and power, as compared to previous solutions relying upon inefficient manual placement of virtual objects in a 3D environment. Other technical benefits not specifically mentioned herein can also be realized through implementations of the disclosed subject matter.

Although the techniques have been described in language specific to structural features and/or methodological acts, it is to be understood that the appended claims are not necessarily limited to the features or acts described. Rather, the features and acts are described as example implementations of such techniques.

The disclosure presented herein also encompasses the subject matter set forth in the following clauses:

Clause 1: A system comprising:
one or more data processing units; and
a computer-readable medium having encoded thereon computer-executable instructions to cause the one or more data processing units to perform operations comprising:
rendering a user interface (UI) on a device communicatively coupled to the system;
receiving an indication that an input has been received from the user via the UI;
in response to receiving the indication, causing an artificial intelligence (AI) model to analyze content of the input and determine an affective state of the user; wherein the affective state is determined using a dual model comparison; and rendering, on the UI, a response based on the determined affective state.

Clause 2: The system of clause 1, wherein the content of the input is analyzed by:
identifying key elements from the input; and
determining one or more subdimensions based on feature analysis of the key elements.

Clause 3: The system of any of clauses 1-2, wherein the content of the input is analyzed by:
identifying key elements from the input; and
assessing valence, intensity, control, context, and expression factors based on the key elements; and
using an emotion map to identify a corresponding emotional label for the input.

Clause 4: The system of any of clauses 1-3, wherein the content of the input is analyzed by:
identifying key elements from the input; and
using an emotion map to identify a corresponding emotional label for the input.

Clause 5: The system of any of clauses 1-4, wherein the dual models include at least one comparison selected from: past vs. present, self vs. others, and expectations vs. reality.

Clause 6: The system of any of clauses 1-5, wherein the expression factors include an internal/external expression factor.

Clause 7: The system of clauses 1-6, wherein the dual model comparison comprises one or more of: past vs. present, future vs. present, present vs. present, self vs. others, self vs. group/society, self's standards vs. actions, expectations vs. reality, or self vs. new information.

Clause 8: The system of clauses 1-7, wherein the affective state is determined based on a mapping of the dual model comparison to a plurality of labels of discrete affective states.

Clause 9: The system of clauses 1-8, wherein the affective state is further determined using a weighting based on one or more personality classification frameworks.

Clause 10: A computer-implemented method for generating responses based on affective states, the method comprising:
rendering a user interface (UI) on a device communicatively coupled to a computing system;
receiving an indication that an input has been received from the user via the UI;
in response to receiving the indication, causing an artificial intelligence (AI) model to analyze content of the input and determine an affective state of the user; wherein the affective state is determined using a dual model comparison; and
rendering, on the UI, a response based on the determined affective state.

Clause 11: The computer-implemented method of clause 10, wherein the content of the input is analyzed by:
identifying key elements from the input; and
determining one or more subdimensions based on feature analysis of the key elements.

Clause 12: The computer-implemented method of any of clauses 10 and 11, wherein the content of the input is analyzed by:
identifying key elements from the input; and
assessing valence, intensity, control, context, and expression factors based on the key elements; and
using an emotion map to identify a corresponding emotional label for the input.

Clause 13: The computer-implemented method of any of clauses 10-12, wherein the content of the input is analyzed by:
identifying key elements from the input; and
using an emotion map to identify a corresponding emotional label for the input.

Clause 14: The computer-implemented method of any of clauses 10-13, wherein the dual models include at least one comparison selected from: past vs. present, self vs. others, and expectations vs. reality.

Clause 15: The computer-implemented method of any of clauses 10-14, wherein the expression factors include an internal/external expression factor.

Clause 11: The computer-implemented method of any of clauses 10-15, wherein the dual model comparison comprises one or more of: past vs. present, future vs. present, present vs. present, self vs. others, self vs. group/society, self's standards vs. actions, expectations vs. reality, or self vs. new information.

Clause 17: The computer-implemented method of any of clauses 10-11, wherein the affective state is further determined using a weighting based on one or more personality classification frameworks.

Clause 18: A system comprising:
means for rendering a user interface (UI) on a device communicatively coupled to the system;
means for receiving an indication that an input has been received from the user via the UI;
means for in response to receiving the indication, causing an artificial intelligence (AI) model to analyze content of the input and determine an affective state of the user; wherein the affective state is determined using a dual model comparison; and
means for rendering, on the UI, a response based on the determined affective state.

Clause 19: The system of clause 18, wherein the content of the input is analyzed by:
identifying key elements from the input; and
determining one or more subdimensions based on feature analysis of the key elements.

Clause 20: The system of any of clauses 18 and 19, wherein the content of the input is analyzed by:
identifying key elements from the input; and
assessing valence, intensity, control, context, and expression factors based on the key elements; and
using an emotion map to identify a corresponding emotional label for the input.

What is claimed is:

1. A system comprising:
one or more data processing units; and
a computer-readable medium having encoded thereon computer-executable instructions to cause the one or more data processing units to perform operations comprising:
rendering a user interface (UI) on a device communicatively coupled to the system;
receiving an indication that an input has been received from the user via the UI;
in response to receiving the indication, causing an artificial intelligence (AI) model to analyze content of the input and determine an affective state of the user; wherein the affective state is determined using a dual model comparison; and
rendering, on the UI, a response based on the determined affective state.

2. The system of claim 1, wherein the content of the input is analyzed by:
identifying key elements from the input; and
determining one or more subdimensions based on feature analysis of the key elements.

3. The system of claim 1, wherein the content of the input is analyzed by:
identifying key elements from the input; and
assessing valence, intensity, control, context, and expression factors based on the key elements; and
using an emotion map to identify a corresponding emotional label for the input.

4. The system of claim 1, wherein the content of the input is analyzed by:
identifying key elements from the input; and
using an emotion map to identify a corresponding emotional label for the input.

5. The system of claim 1, wherein the dual models include at least one comparison selected from: past vs. present, self vs. others, and expectations vs. reality.

6. The system of claim 3, wherein the expression factors include an internal/external expression factor.

7. The system of claim 1, wherein the dual model comparison comprises one or more of: past vs. present, future vs. present, present vs. present, self vs. others, self vs. group/society, self's standards vs. actions, expectations vs. reality, or self vs. new information.

8. The system of claim 1, wherein the affective state is determined based on a mapping of the dual model comparison to a plurality of labels of discrete affective states.

9. The system of claim 1, wherein the affective state is further determined using a weighting based on one or more personality classification frameworks.

10. A computer-implemented method for generating responses based on affective states, the method comprising:
rendering a user interface (UI) on a device communicatively coupled to a computing system;
receiving an indication that an input has been received from the user via the UI;
in response to receiving the indication, causing an artificial intelligence (AI) model to analyze content of the input and determine an affective state of the user; wherein the affective state is determined using a dual model comparison; and
rendering, on the UI, a response based on the determined affective state.

11. The method of claim 10, wherein the content of the input is analyzed by:
identifying key elements from the input; and
determining one or more subdimensions based on feature analysis of the key elements.

12. The method of claim 10, wherein the content of the input is analyzed by:
identifying key elements from the input; and
assessing valence, intensity, control, context, and expression factors based on the key elements; and
using an emotion map to identify a corresponding emotional label for the input.

13. The method of claim 10, wherein the content of the input is analyzed by:
identifying key elements from the input; and
using an emotion map to identify a corresponding emotional label for the input.

14. The method of claim 10, wherein the dual models include at least one comparison selected from: past vs. present, self vs. others, and expectations vs. reality.

15. The method of claim 12, wherein the expression factors include an internal/external expression factor.

16. The method of claim 10, wherein the dual model comparison comprises one or more of: past vs. present, future vs. present, present vs. present, self vs. others, self vs. group/society, self's standards vs. actions, expectations vs. reality, or self vs. new information.

17. The method of claim 10, wherein the affective state is further determined using a weighting based on one or more personality classification frameworks.

18. A system comprising:
means for rendering a user interface (UI) on a device communicatively coupled to the system;
means for receiving an indication that an input has been received from the user via the UI;
means for in response to receiving the indication, causing an artificial intelligence (AI) model to analyze content of the input and determine an affective state of the user;
wherein the affective state is determined using a dual model comparison; and
means for rendering, on the UI, a response based on the determined affective state.

19. The system of claim 18, wherein the content of the input is analyzed by:
identifying key elements from the input; and
determining one or more subdimensions based on feature analysis of the key elements.

20. The system of claim 18, wherein the content of the input is analyzed by:
identifying key elements from the input; and
assessing valence, intensity, control, context, and expression factors based on the key elements; and
using an emotion map to identify a corresponding emotional label for the input.
